(19) United States
(12) Patent Application Publication
(10) Pub. No.: US 2026/0115756 A1
(43) Pub. Date: Apr. 30, 2026

(54) CURING DEVICE AND PRINTING SYSTEM

(71) Applicant: Makeblock Co., Ltd., Shenzhen (CN)

(72) Inventors: Wenhua WANG, Shenzhen (CN); Jiong YANG, Shenzhen (CN); Shaoqiang XU, Shenzhen (CN)

(73) Assignee: Makeblock Co., Ltd., Shenzhen (CN)

(21) Appl. No.: 19/420,312

(22) Filed: Dec. 15, 2025

Related U.S. Application Data
(63) Continuation of application No. PCT/CN2025/120428, filed on Sep. 10, 2025.

(30) Foreign Application Priority Data
Oct. 30, 2024 (CN) 202411532535.3

(51) Int. Cl. B05C 9/14; B41J 3/407; B41J 11/00; B41J 29/377

(52) U.S. Cl. CPC B05C 9/14; B41J 3/4078; B41J 11/0024; B41J 29/377

(57) ABSTRACT

A curing device and a printing system. The curing device includes a housing, and a powder-dispensing component, a transport component, and a curing component which are disposed within the housing. The housing defines a feeding port, and the feeding port is configured to allow a film to enter the housing through the feeding port. The powder-dispensing component is disposed between the feeding port and the transport component, and the powder-dispensing component is configured to contain hot-melt adhesive powder and dust the hot-melt adhesive powder to the film. The transport component is configured to transport the film. The curing component is disposed in a transport path of the film and is configured to cure the film to melt the hot-melt adhesive powder on the film.

### CROSS-REFERENCE TO RELATED APPLICATIONS

This application is a continuation of International Application No. PCT/CN2025/120428 filed Sep. 10, 2025, which claims priority to Chinese Patent Application No. 202411532535.3 filed Oct. 30, 2024, the entire disclosures of both of which are incorporated herein by reference.

### TECHNICAL FIELD

The present disclosure relates to the field of printing technologies, and in particular, to a curing device and a printing system.

### BACKGROUND

Direct to film (DTF) printing is to print an image or design directly onto a specialized film, which is then thermal-transferred to various textiles or other materials. The DTF printing has advantages of high precision, high color saturation, and excellent durability. The DTF printing can achieve more complex designs and colors, while being readily operable and highly efficient.

The DTF printing is widely applied to industries such as clothing, advertisements, and gift, which provides more creative space and production flexibility for designers and enterprises

### SUMMARY

One aspect of the present disclosure discloses a curing device. The curing device includes a housing, and a powder-dispensing component, a transport component, and a curing component which are disposed within the housing. The housing defines a feeding port, and the feeding port is configured to allow a film to enter the housing through the feeding port. The powder-dispensing component is disposed between the feeding port and the transport component, and the powder-dispensing component is configured to contain hot-melt adhesive powder and dust the hot-melt adhesive powder to the film. The transport component is configured to transport the film. The curing component is disposed in a transport path of the film and is configured to cure the film to melt the hot-melt adhesive powder on the film.

Another aspect of the present disclosure further provides a printing system. The printing system includes a printer and a curing device. The curing device includes a housing, and a powder-dispensing component, a transport component, and a curing component which are disposed within the housing. The housing defines a feeding port and an installation space, the installation space is located outside the housing, the feeding port connects the installation space with the interior of the housing, and the feeding port is configured to allow the film to enter the housing through the feeding port. The powder-dispensing component is disposed between the feeding port and the transport component, and the powder-dispensing component is configured to contain hot-melt adhesive powder and dust the hot-melt adhesive powder to the film. The transport component is configured to transport the film. The curing component is disposed in a transport path of the film and is configured to cure the film to melt the hot-melt adhesive powder on the film. The printer is located in the installation space, and the curing device is configured to receive the film printed with the design by the printer and cure the film.

### BRIEF DESCRIPTION OF THE DRAWINGS

FIG. 1 is a schematic structural view of a printing system according to an embodiment of the present disclosure.

FIG. 2 is a schematic structural view of a curing device according to an embodiment of the present disclosure from a first perspective.

FIG. 3 is a cross-sectional view of FIG. 2, taken along A-A direction.

FIG. 4 is a schematic view showing an internal structure of a curing device from a first perspective according to an embodiment of the present disclosure.

FIG. 5 is a schematic view showing an internal structure of a curing device from a second perspective according to an embodiment of the present disclosure.

FIG. 6 is a schematic structural view of a powder-dispensing component and a buffer component according to an embodiment of the present disclosure.

FIG. 7 is a schematic structural view of a buffer component according to an embodiment of the present disclosure.

FIG. 8 is a schematic structural view of a transport component from a first perspective according to an embodiment of the present disclosure.

FIG. 9 is a schematic structural view of a transport component from a second perspective according to an embodiment of the present disclosure.

FIG. 10 is an enlarged view of FIG. 9 at circle C.

FIG. 11 is an enlarged view of FIG. 3 at circle B.

FIG. 12 is a schematic structural view of a powder-dispensing mechanism according to an embodiment of the present disclosure.

FIG. 13 is a schematic structural view of a powder-dispensing roller according to an embodiment of the present disclosure.

FIG. 14 is a schematic structural view of a powder-dispensing component from a first perspective according to an embodiment of the present disclosure.

FIG. 15 is a schematic structural view of a curing device from a second perspective according to an embodiment of the present disclosure.

FIG. 16 is a schematic view showing an interior structure of a powder-dispensing component according to an embodiment of the present disclosure.

FIG. 17 is a schematic structural view of a powder-dispensing component from a second perspective according to an embodiment of the present disclosure.

FIG. 18 is a cross-sectional view of FIG. 17, taken along E-E direction.

FIG. 19 is a schematic structural view of a curing component according to an embodiment of the present disclosure.

FIG. 20 is a cross-sectional view of FIG. 19, taken along D-D direction.

Description of Reference Signs: 001-printing system; 01-curing device; 02-printer; 1-housing; 11-feeding port; 12-powder filling port; 13-frame; 14-side plate; 15-installation space; 16-first accommodating chamber; 17-second accommodating chamber; 2-buffer component; 21-swing member; 211-feeding surface; 2111-first transport sub-surface; 2112-second transport sub-surface; 213-powder leakage hole; 214-avoidance groove; 22-second motor; 23-second sensor; 24-bracket; 241-installation plate; 25-limiting member; 26-third sensor; 27-first sensor; 3-powder-dispensing component; 31-powder-dispensing mechanism; 311-powder-dispensing bin; 3111-reinforcing rib 311; 313-powder-dispensing roller; 3131-powder groove; 314-third motor; 315-powder-scraping member; 32-powder storage mechanism; 321-powder storage bin; 321a-powder recovery portion; 321a1-powder recovery chamber; 321b-powder storage portion; 321b1-powder storage chamber; 3211-powder guiding groove; 3212-first limiting protrusion; 3213-second limiting protrusion; 3214-first through hole; 32141-first notch; 3215-powder recovery port; 3216-sleeve; 322-powder filling bin; 3222-third limiting protrusion; 323-fourth sensor; 324-rebound member; 325-grating; 33-powder circulation mechanism; 331-powder circulation synchronous belt; 3311-protrusion; 3312-body; 332-fourth motor; 333-tensioning mechanism; 3331-tensioning member; 3332-tensioning screw; 334-powder unloading member; 335-transmission structure; 3351-driving wheel; 3352-driven wheel; 34-powder-dispensing mechanism; 341-fifth motor; 342-rotating shaft; 343-tapping member; 3431-clamp; 3432-flexible member; 4-transport component; 41-first transport sub-component; 411-first transport module; 412-first transmission member; 413-first limiting member; 4131-third guiding member; 42-second transport sub-component; 421-second transport module; 422-second transmission member; 423-second limiting member; 43-transmission sub-component; 431-first gear; 432-second gear; 433-third gear; 44-first motor; 45-guiding member; 451-first guiding member; 452-second guiding member; 46-first fitting portion; 47-encoding disk; 48-sixth sensor; 5-curing component; 51-box; 511-air supply port; 512-aluminum foil layer; 513-thermal insulation layer; 514-mirror layer; 52-heating member; 53-exhaust structure; 531-exhaust fan; 532-first exhaust pipe; 533-second exhaust pipe; 54-fan; 55-isolation box; 6-powder filling cover; 7-take-up component; 71-take-up bin; 711-take-up chamber; 712-take-up port; 72-guide; 8-fifth sensor; 9-controller; 100-film; a-length direction; b-height direction; c-width direction.

### DETAILED DESCRIPTION

The present disclosure provides a curing device and a printing system. In order to make objects, technical solutions, and effects of the present disclosure clearer and more definite, the present disclosure is further described in detail below with reference to the accompanying drawings and embodiments. It can be understood that specific embodiments described herein are only intended to explain the present disclosure, but not to limit the present disclosure.

In the description of the present disclosure, it can be understood that, terms such as “upper”, “lower”, “left”, “right” and the like indicate orientation or position relationships based on orientation or position relationships illustrated in the drawings, which are only used to facilitate the description of the present disclosure and simplify the description, rather than indicating or implying that the device or element referred to must have a specific orientation, or be configured or operated in a specific orientation, and therefore cannot be understood as a limitation to the present disclosure. In addition, “first” and “second” are only used for the purpose of description, and cannot be understood as indicating or implying relative importance or implicitly indicating the number of indicated technical features. Therefore, features defined by “first” and “second” may explicitly or implicitly include one or more of the features. In the description of the present disclosure, unless otherwise specified, the meaning of “a plurality of” or “multiple” means two or more.

In the description of the present disclosure, it can be noted that, unless specified or limited otherwise, the terms “mounted”, “coupled”, and “connected” will be understood broadly, and may be, for example, fixed connection, detachable connection, or integral connection; may be mechanical connection, electrical connection, or may communication connection; may be direct connection, indirect connection via an intermediate medium, or inner communication of two elements, or an interaction relationship between two elements. The specific meanings of the above terms in the present disclosure can be understood by those skilled in the art according to specific situations.

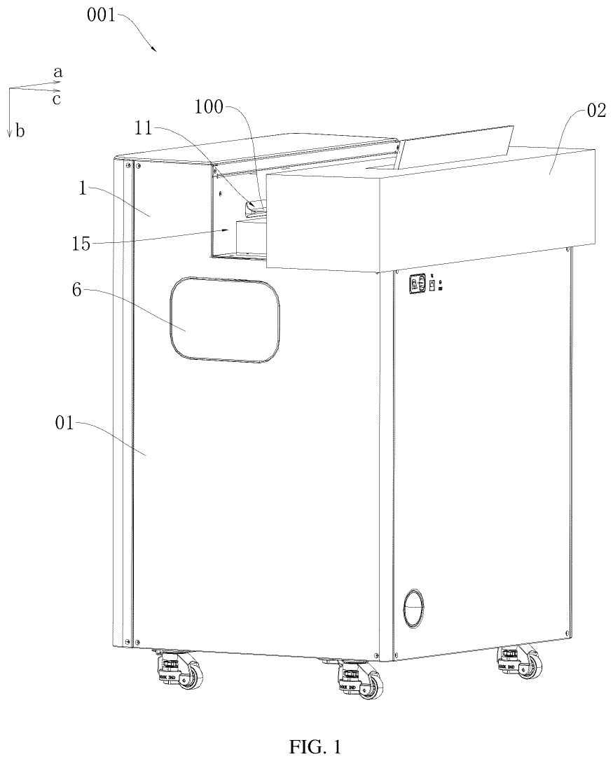

FIG. 1 is a schematic structural view of a printing system 001 provided in the present disclosure.

As illustrated in FIG. 1, the present disclosure provides a printing system 001. The printing system 001 includes a printer 02 and a curing device 01. The printer 02 may include a print head. Exemplarily, the print head may be an ink-jet print head, and the printer may be an ink-jet printer. The printer 02 is configured to print a design onto a film 100. The curing device 01 may be disposed at one side where a discharge port of the printer 02 is located. The curing device 01 is configured to receive the film 100 printed with the design by the printer 02, and is configured to dry the design on the film 100 printed with the design by the printer 02, dust hot-melt adhesive powder onto the film 100, and melt the hot-melt adhesive powder on the film 100, so that the design on the film 100 can be transferred to other objects (such as clothes and caps). The printing system 001 may be a direct to film (DTF) printing system, which is not limited herein.

Generally, the film 100 may be a polyethylene terephthalate (PET) film. In an embodiment, the thickness of the film 100 may be 0.75 mm. The film 100 of the above material and thickness has good transferability, which can improve the definition of design transferred onto products.

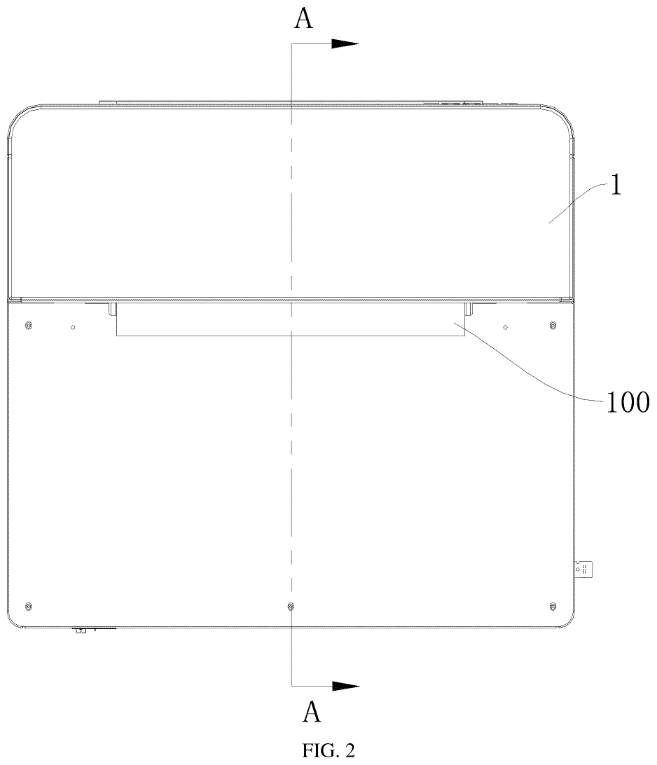

FIG. 2 is a schematic structural view of the curing device provided in the present disclosure from a first perspective.

As illustrated in FIGS. 1 and 2, the curing device 01 includes a housing 1. The housing 1 defines a feeding port 11, and the feeding port 11 is configured to allow to the film 100 to pass through. The film 100 printed with a design can enter the curing device 01 through the feeding port 11, so that operations such as dusting and curing can be performed.

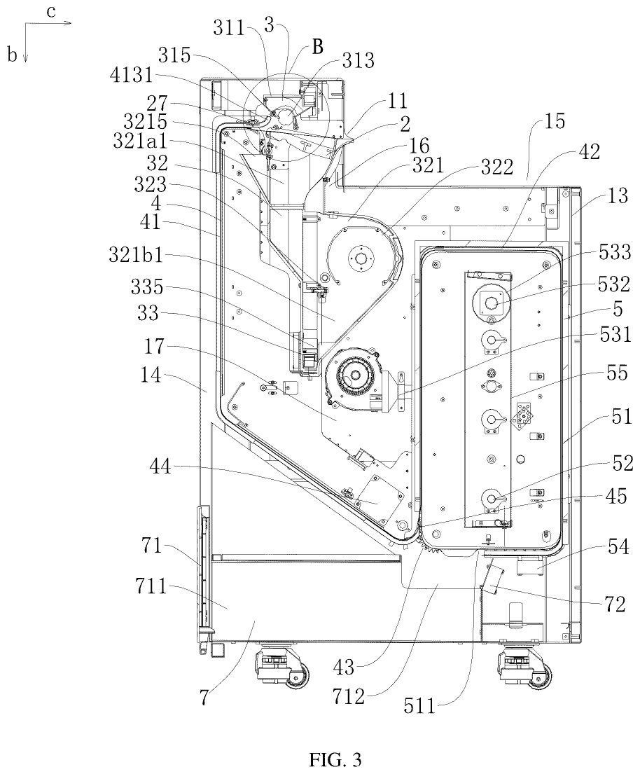

FIG. 3 is a cross-sectional view of FIG. 2, taken along A-A direction.

As illustrated in FIG. 3, in some embodiments, the housing 1 may include a frame 13 and side plates 14 fixed on the frame 13. The frame 13 forms a frame structure. The side plates 14 surround an outer side of the frame 13, and the feeding port 11 can be defined on a side plate 14 which is located on one side of the housing 1 facing the printer.

As illustrated in FIGS. 2 and 3, the housing 1 defines an accommodating chamber, and the curing device 01 further includes a powder-dispensing component 3, a transfer component 4, and a curing component 5. Optionally, the curing device 01 can further include a buffer component 2. The buffer component 2, the powder-dispensing component 3, the transport component 4, and the curing component 5 are mounted in the accommodating chamber to improve the integrity of the curing device 01.

The housing 1 defines a feeding port 11, and the film 100 enters the housing 1 through the feeding port 11. The buffer component 2 is disposed between the feeding port 11 and the transport component 4 and is configured to guide the film 100 entering through the feeding port 11 to the transport component 4. The buffer component 2 can provide buffering during the transport of the film 100, and reduce the transport speed of the film 100.

The powder-dispensing component 3 is disposed between the feeding port 11 and the transport component 4, the buffer component 2 passes through the powder-dispensing component 3, and the powder-dispensing component 3 is configured to contain hot-melt adhesive powder and dust the hot-melt adhesive powder to the film 100. When the film 100 is buffered in the buffer component 2, the powder-dispensing component 3 is configured to dispense the hot-melt adhesive powder from above the film 100 to the film 100, and recovery excessive hot-melt adhesive powder.

The transport component 4 is configured to transport the film 100, and the curing component 5 is disposed in a transport path of the film 100 and is configured to cure the film 100, to melt the hot-melt adhesive powder on the film 100.

The above structure achieves automatic operations of feeding, dusting, transport, and curing of the film 100, which improves the curing efficiency of the film 100, and improves the usage experience.

In the present disclosure, the transport path of the film 100 refers to a path along which the film 100 moves inside the housing 1 after entering the housing 1 through the feeding port 11. A transport direction of the film 100 refers to a direction in which the film 100 enters the housing 1 through the feeding port 11 and moves inside the housing 1.

As illustrated in FIGS. 1 and 2, in some embodiments, the curing device 01 has a length direction a, a height direction b, and a width direction c. The feeding port 11 is disposed on one side of the housing 1 in the width direction c of the curing device 01. The powder-dispensing component 3 extends in the height direction b of the curing device 01 and the length direction a of the curing device 01. The buffer component 2 extends in the length direction a of the curing device 01. The curing component 5 is disposed on one side of the powder-dispensing component 3 in the width direction c of the curing device 01. The curing component 5 and the feeding port 11 are located on the same side of the curing device 01 in the width direction c of the curing device 01.

In the above, positions of various components of the curing device 01 are rationally arranged, and the compactness of the structure of the curing device 01 is improved and the volume of the curing device 01 is reduced without compromising the performance of the device. By providing the curing component 5 on one side of the powder-dispensing component 3 in the width direction c, a space suitable for the transport component 4 to extend is created on the other side of the powder-dispensing component 3 facing away from the curing device 01 in the width direction c. The curing component 5 and the feeding port 11is disposed on the same side of the curing device 01 in the width direction c of the curing device 01. Since a feeding end of the feeding port 11 faces towards an externally connected device, the curing component 5 is located at one side close to an external device when in use, which prevents the heat generated by the curing component 5 from causing discomfort to the operator during operation of the device, thereby improving the usage experience.

In some embodiments, an installation space 15 for installing an external device is defined on an outer side of an upper part of the housing 1. A first accommodating chamber 16 located in parallel with the installation space 15 in the width direction c of the curing device 01 is defined in the housing 1. A second accommodating chamber 17 located below the first accommodating chamber 16 and the installation space 15 in the height direction b of the curing device 01 is defined in the housing 1. The feeding port 11 is in communication with the first accommodating chamber 16 and the installation space 15. The buffer component 2 is disposed in the first accommodating chamber 16. Part of the powder-dispensing component 3 is disposed in the first accommodating chamber 16, the other part of the powder-dispensing component 3 is disposed in the second accommodating chamber 17. The curing component 5 is disposed in the second accommodating chamber 17 and located below the installation space 15. In this way, the external device (such as a printer) can be directly mounted in the installation space 15, thereby saving the installation area, shortening a transmission distance of the film 100 transmitted from the external device to the curing device 01, and improving the printing efficiency. The first accommodation chamber 16 is disposed in parallel with the installation space 15, and the buffer component 2 is disposed in the first accommodation chamber 16, so that the film 100 entering the curing device 01 from the external device through the feeding port 11 can be directly transported to the buffer component 2. One part of the powder-dispensing component 3 is disposed in the first accommodating chamber 16, and the other part of the powder-dispensing component 3 is disposed in the second accommodating chamber 17, so as to make full use of the space in the height direction and avoid occupying a large space in the width direction. The curing component 5 is disposed in the second accommodating chamber 17 and located below the installation space 15, and therefore the space in the height direction and the space in the width direction are further fully utilized, so that the structure layout of the curing device is more compact, the volume of the curing device is smaller, and user convenience during operation is enhanced. The feeding port 11 connects the installation space 15 with the interior of the housing 1. In some embodiments, the feeding port 11 connects the installation space 15 with the first accommodating chamber 16.

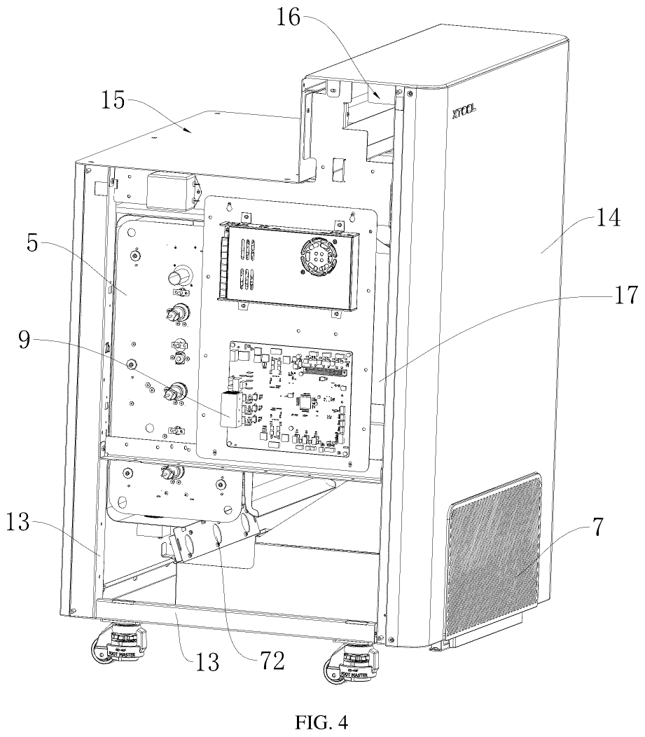

FIG. 4 is a schematic view showing an internal structure of the curing device from a first perspective according to an embodiment of the present disclosure.

As illustrated in FIGS. 3 and 4, the curing device 01 further includes a take-up component 7 disposed at the bottom of the housing 1. The take-up component 7 includes a take-up bin 71, and the take-up bin 71 is configured to store the cured film 100. By means of the take-up bin 71, automatic storage of the cured film 100 can be realized, thereby realizing an integrated automatic operation of the curing device 01. The take-up bin 71 defines a take-up chamber 711 and a take-up port 712, and the take-up port 712 is in communication with the take-up chamber 711 and the second accommodating chamber 17.

The take-up port 712 is opposite to the transport component 4 disposed below the curing component 5, so that the film 100 on the transport component 4 can enter the take-up chamber 711 through the take-up port 712. The take-up component 7 can provide a storage space for the cured film 100, so as to timely store the cured film 100, thereby reducing unnecessary waiting time and improving the usage experience. The take-up component 7 is located on the other side of the powder-dispensing component 3 in the width direction c of the curing device 01, so that the space of the second accommodating chamber 17 can be effectively utilized to optimize the internal layout of the device. Furthermore, the take-up component 7 and the curing component 5 are located on different sides of the curing device 01 in the width direction c, so that the operator does not need to approach the curing component 5 when taking out the film 100 from the take-up component 7, thereby avoiding being burned.

The take-up bin 71 is detachably mounted to the housing 1 so as to facilitate the extraction of the take-up bin 71. The take-up component 7 further includes a guide 72. The guide 72 is disposed at one end of the take-up bin 71 close to the take-up port 712, so as to guide the film 100 detaching from the transport component 4 into the take-up chamber 711. By providing the guide 72, the cured film 100 can be prevented from accumulating at a position near the take-up port 712 in the take-up bin 71. Exemplarily, the guide 72 may be an element (such as an inclined plate) having an inclined or a curved surface, or a fan. In this embodiment, the guide 72 is configured as a fan, and an air outlet of the fan faces towards the take-up port 712. Multiple fans may be disposed at a position where the transport component 4 drops the film 100, and the multiple fans are disposed at intervals in a width direction of the film 100, so that the film 100 can be subjected to a uniform pushing force in the width direction, thereby being stored in the take-up bin 71 more regularly.

In some embodiments, the take-up component 7 includes a film-winding mechanism, and the material-collecting mechanism is disposed in the take-up bin 71. The film-winding mechanism is rotatable, and the cured film 100 can be wound around the film-winding mechanism, so as to store the film 100.

The take-up component 7 may include a fifth sensor (not illustrated in the figure). The fifth sensor may be disposed inside the take-up bin 71 or on a surface, opposite to the take-up chamber 71, of the housing 1. The fifth sensor is configured to detect a storage quantity of the film 100 in the take-up bin 71. After a certain amount of film 100 is stored in the take-up chamber 71, the fifth sensor can send an alarm signal to remind an operator to take out the film 100 in the take-up bin 71. In some examples, the fifth sensor may be a photoelectric sensor or the like.

As illustrated in FIG. 4, the curing device 01 further includes a controller 9, and the controller 9 can be disposed in the housing 1. In some examples, the controller 9 may be a programmable logic controller (PLC) controller. The controller 9 is electrically connected to the buffer component 2, the powder-dispensing component 3, the transport component 4, and the curing component 5. The controller 9 is configured to realize centralized and unified control of the whole device, so as to improve the accuracy of automatic control of the curing device 01. The controller 9 may include a main board, and electronic components and interfaces disposed on the main board, etc. The main board may be fixed on the frame 13 or the side plate 14. In some examples, the controller 9 may be disposed in the second accommodating chamber 17 and located on one side of the powder-dispensing component 3 in the length direction a of the curing device 01. In this way, the structure layout is more compact, and the space of the second accommodating chamber 17 is fully utilized.

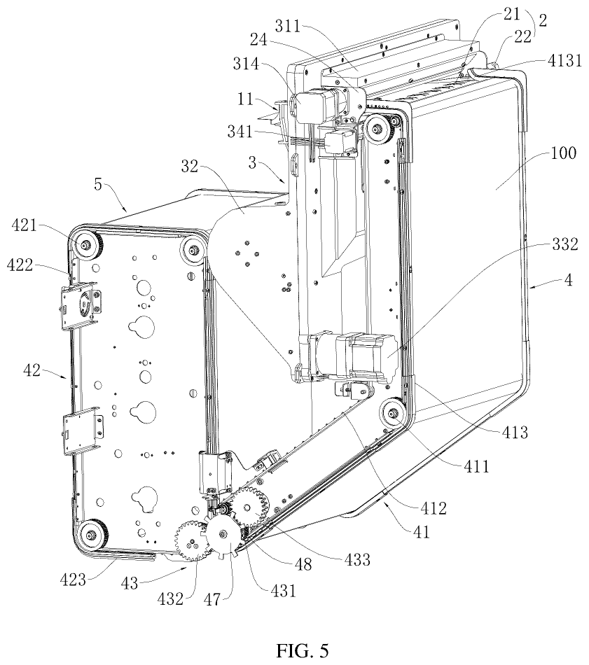

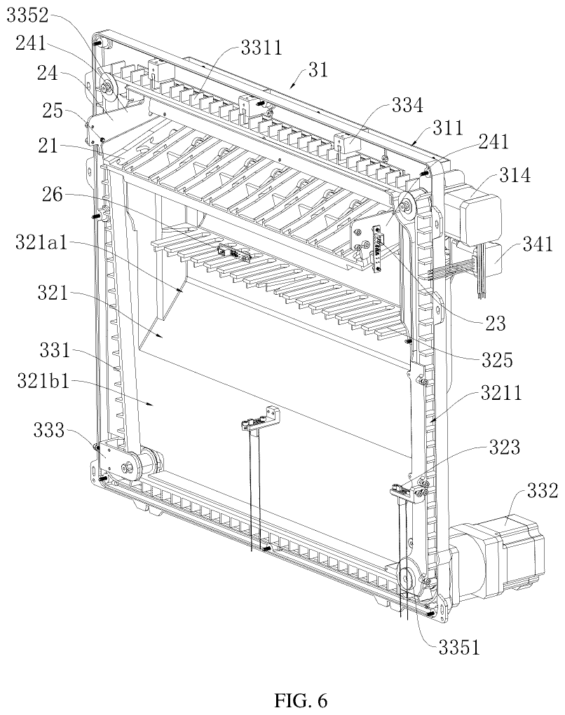

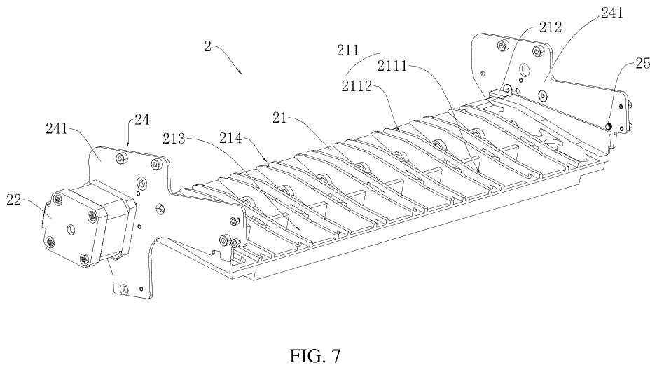

FIG. 5 is a schematic view showing an interior structure of the curing device from a second perspective according to the present disclosure. FIG. 6 is a schematic view of the powder-dispensing component and the buffer component according to the present disclosure. FIG. 7 is a schematic structural view of the bumper component provided in the present disclosure.

As illustrated in FIG. 5, the buffer component 2 includes a bracket 24, and the bracket 24 is fixed in the housing 1.

As illustrated in FIGS. 6 and 7, the bracket 24 includes two installation plates 241. The two installation plates 241 may be disposed opposite to each other in the length direction a of the curing device 01, and are respectively located at two sides of a transport direction of the film 100.

The buffer component 2 includes a swing member 21, and the swing member 21 is mounted swingably on the bracket 24 and, in particular, mounted swingably on at least one installation plate 241.

In some embodiments, the swing member 21 may be of a plate body structure in a grid shape. The swing member 21 defines powder leakage holes 213. By providing the powder leakage holes 213, the friction force between the swing member 21 and the film 100 can be reduced. Furthermore, excess hot-melt adhesive powder dusted downwards from the powder-dispensing component 3 or the hot-melt adhesive powder shaking off the film 100 can fall down from the powder leakage holes 213, so as to achieve the recovery of the hot-melt adhesive powder.

The swing member 21 is disposed opposite to the feeding port 11. After entering the curing device 01 through the feeding port 11, the film 100 is transmitted to the swing member 21. The swing member 21 is disposed on the bracket 24 and is swingable relative to the bracket 24. The swing member 21 has a first position and a second position. The swing member 21 is swingable within a range between the first position and the second position.

In some examples, the swing member 21 has a feeding surface 211 with a changed inclination angle. When the swing member 21 is at the first position, two ends of the swing member 21 corresponding to the feeding surface 211 are respectively close to the feeding port 11 and the transport component 4. When the swing member 21 is at the second position, the feeding surface 211 is relatively far away from the feeding port 11, and there is a certain distance between the feeding surface 211 and the feeding port 11. The first position may be a maximum height position that can be reached when the swing member 21 swings upward, and the second position may be a swing zero position of the swing member 21, that is, an initial position of the swing member 21. In other embodiments, an upward and downward swing amplitude of the swing member 21 may exceed a range defined between the first position and second position.

In an initial state, the swing member 21 is at the second position. When the film 100 reaches the buffer component 2 through the feeding port 11, the swing member 21 swings upwards to the first position, two ends of the swing member 21 can be respectively close to the feeding port 11 and the transport component 4, and the film 100 can pass through the feeding surface 211 of the swing member 21 and be delivered to the transport component 4. The film 100 delivered to the transport component 4 can be fixed on the transport component 4. After the film 100 is fixed on the transport component 4, the swing member 21 can swing downwards to the second position. The transport component 4 does not exert a tensioning action on the film 100, and the film 100 is pressed down under the action of gravity to be of an arc shape.

As illustrated in FIG. 7, the feeding surface 211 includes a first transport sub-surface 2112 and a second transport sub-surface 2111 which are connected, where both the first transport sub-surface 2112 and the second transport sub-surface 2111 are curved surfaces. The first transport sub-surface 2112 is closer to the feeding port 11 than the second transport sub-surface 2111. In a width direction of the swing member 21, a tangential angle of the first transport sub-surface 2112 is gradually increased, and a tangential angle of the second transport sub-surface 2111 is gradually decreased. The first transport sub-surface 2112 is connected to the second transport sub-surface 2111 to form a changed inclination angle, which enables the film 100 to more smoothly pass through the buffer component 2 to reach the transport component 4 to some extent.

The buffer component 2 includes a second motor 22 disposed on the bracket 24 and drivingly connected to the swing member 21 to drive the swing member 21 to swing.

As illustrated in FIGS. 3 and 6, the swing member 21 is disposed between the two installation plates 241 and is rotatable with respect to the installation plates 241 so as to swing. The installation plates 241 each define a connecting hole, and one end of the swing member 21 is rotatably connected to a connecting hole on one of the installation plates 241 through a shaft body. An output shaft of the second motor 22 passes through a connection hole on the other one of installation plates 241, and is drivingly connected to the other end of the swing member 21, so as to achieve the rotation of the swing member 21. Further, the second motor 22 is connected to one end of the swing member 21 in the transport direction of the film 100, so that the swing member 21 can achieve a larger swing amplitude.

As illustrated in FIGS. 3 and 6, the buffer component 2 includes a first sensor 27, the first sensor 27 is disposed at the rear of the swing member 21 in the transport direction. The first sensor 27 is configured to detect whether the film reaches the transport component 4. When the first sensor 27 detects the film 100 reaches the transport component 4 from the buffer component 2, the first sensor 27 sends a control signal to the controller 9, and the controller 9 controls the second motor 22 according to the control signal, so that the second motor 22 controls the swing member 21 to swing downwards to the second position, to enable the film 100 to be buffered on the buffer component 2 and form an arc that bends downwards. In this way, the film 100 is prevented from being accumulated, so that the powder-dispensing component 3 can evenly powder the film 100.

The buffer component 2 includes a second sensor 23, where a sensing area of the second sensor 23 faces the swing member 21. The second sensor 23 is configured to detect a position of the swing member 21 so as to judge whether the swing member 21 swings to the first position. In this embodiment, the second sensor 23 may be disposed at one side of the buffer component 2 facing the feeding port 11, and the second sensor 23 may be disposed close to the first position.

When the swing member 21 swings to the first position, the second sensor 23 can generate an excitation signal; the controller 9 can control, according to the excitation signal, the second motor 22 to stop rotating. In this case, the film 100 passes through the feeding surface 211 of the swing member 21 and reaches the transport component 4. As such, the feeding surface 211 of the swing member 21 can contact the passing film 100, so as to support the film 100 and enable the film 100 to successfully be transported to the transport component 4.

As illustrated in FIG. 6, the buffer component 2 further includes a third sensor 26. The third sensor 26 is disposed below the first position and is configured to detect whether the film 100 sags to a lower limit position when the swing member 21 is at the second position, so as to control the transport speed of the film 100 on the transport component 4. The third sensor 26 may be disposed on the housing 1.

In the above, when the film 100 reaches and is fixedly to the transport component 4, the second motor 22 rotates reversely to control the swing member 21 to swing downwards. The transport component 4 stops the transport of the film 100, and the film 100 will sag and form a downward-curving arc in the buffer component 2 under the pushing action of the printer. When the film 100 is bent to a certain degree, the lower limit position of the film 100 triggers the third sensor 26 to generate a signal. The transport component 4 is activated to transport the film 100 downstream. When the lower limit position of the film 100 is out of the sensing range of the third sensor 26, the transport component 4 stops working, and the film 100 forms a downward-curving arc in the buffer component 2 again, which circulates in this way, so as to realize automatic feeding of the film 100.

In some embodiments, the first sensor 27, the second sensor 23, and the third sensor 26 may be photoelectric sensors or other types of sensors. The first sensor 27, the second sensor 23 and the third sensor 26 are electrically connected to the controller 9.

In some embodiments, as illustrated in FIG. 5, a limiting member 25 is disposed on at least one of the installation plates 241, the limiting member 25 is disposed on one side of the installation plate 241 facing the swing member 21, the limiting member 25 protrudes from a surface of the installation plate 241, and the limiting member 25 is configured to limit a swing range of the swing member 21. When the swing member 21 swings upwards to the first position, the limiting member 25 can abut against the swing member 21, so as to restrict the swing member 21 from continuing to swing upwards, and ensure that the swing member 21 swings upwards to a position, so that the film 100 can smoothly reach the transport component 4.

As illustrated in FIGS. 3 and 5, in some embodiments, the transport component 4 is disposed downstream of the buffer component 2. The transport component 4 is configured to transport the film 100, and the film 100 can be delivered from the buffer component 2 to the curing component 5. The transport component 4 is further configured to transport the film 100 such that the film 100 can move relative to the curing component 5.

With the moving of the transport component 4, the film 100 can be driven to be transported to downstream components, so that the film 100 can be transported without providing a transport roller in the curing device 01. The transport component 4 can transport a single sheet of film 100 with a short length, thereby improving the flexibility of use of the curing device 01 and avoiding the waste of the film 100.

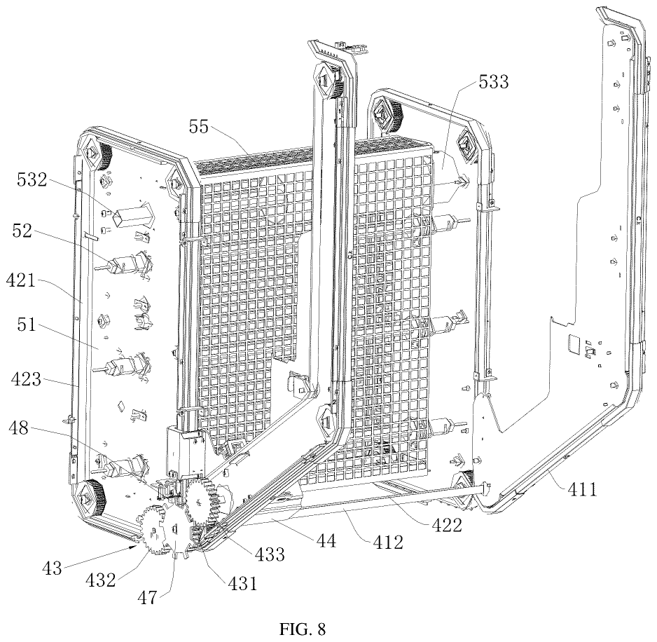

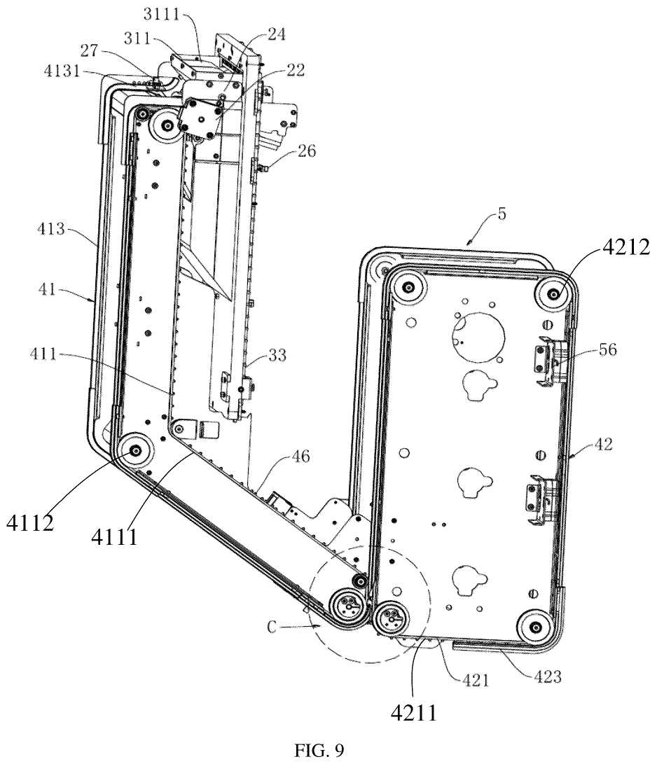

FIG. 8 is a schematic structural view of the transport component provided in the present disclosure from a first perspective, and FIG. 9 is a schematic structural view of the transport component provided in the present disclosure from a second perspective.

As illustrated in FIGS. 3 and 5, the transport component 4 includes a first transport sub-component 41, a second transport sub-component 42, a transmission sub-component 43, and a first motor 44. The first motor 44 is drivingly connected to the transmission sub-component 43, and the transmission sub-component 43 is drivingly connected to the first transport sub-component 41 and the second transport sub-component 42. Part of the first transport sub-component 41 is located at one side of the powder-dispensing component 3 facing away from the feeding port 11, and part of the first transport sub-component 41 is located below the powder-dispensing component 3. The second transport sub-component 42 at least encircles part of the powder-dispensing component 5. During transport of the film 100 by the transport component 4, the film 100 can be transferred from the first transport sub-component 41 to the second transport sub-component 42.

The transmission sub-component 43 is drivingly connected to the first transport sub-component 41 and the second transport sub-component 42, the number of the first motors 44 can be reduced, thereby simplifying the structure of the device. In addition, the transmission sub-component 43 is connected to the first transport sub-component 41 and the second transport sub-component 42 in a transmission manner, which can improve the precision of synchronous transmission of the first transport sub-component 41 and the second transport sub-component 42, thereby improving the transport stability of the film 100.

The first transport sub-component 41 can deliver the film 100 to the front of the curing component 5, and the second transport sub-component 42 can transfer the film 100 around the curing component 5, so as to make full use of the curing region of the curing component 5, and achieve more sufficient curing of the film 100. At the same time, by reasonably laying out the first transport sub-component 41, the space is fully utilized, and the volume of the curing device 01 is reduced.

Referring to FIGS. 8 and 9, in some embodiments, the first transport sub-component 41 includes two first transport modules 411 and a first transmission member 412. The two first transport modules 411 are spaced apart in the length direction a, and the first transmission member 412 is drivingly connected to the two first transport modules 411. The first transmission member 412 can achieve synchronous transmission of the two first transport modules 411, and the two first transport modules 411 can support two ends of the film 100.

Exemplarily, the first transport module 411 includes a first synchronous belt 4111 and multiple first transmission wheels 4112. In the first transport module 411, the first synchronous belt 4111 can be engaged with the multiple first transmission wheels 4112, a connecting line of the multiple first transmission wheels 4112 can define a polygon, and the multiple first transmission wheels 4112 can support the first synchronous belt 4111 and drive the first synchronous belt 4111 to move. The first transmission member 412 may extend in the length direction a of the curing device 01. The first transmission member 412 may be a transmission shaft. One end of the first transmission member 412 is fixed to a first transmission wheel 4112 of one first transport module 411, and the other end of the first transmission member 412 is fixed to a first transmission wheel 4112 of the other first transport module 411. Any one of the first transmission wheels 4112 in one of the first transport modules 411 is connected to the transmission sub-component 43. In some embodiments, the second transport sub-component 42 includes two second transport modules 421 and a second transmission member 422, and the two second transport modules 421 are spaced apart in the length direction a of the curing device 01. The second transmission member 422 is drivingly connected to the two second transport modules 421. The second transmission member 422 can achieve synchronous transmission of the two second transport modules 421, and the two second transport modules 421 can support two ends of the film 100.

Exemplarily, the second transport module 421 includes a second synchronous belt 4211 and multiple second transmission wheels 4212. In the second transport module 421, the second synchronous belt 4211 can be engaged with the multiple second transmission wheels 4212, a connecting line of the multiple second transmission wheels 4212 can define a polygon, and the multiple second transmission wheels 4212 can support the second synchronous belt 4211 and drive the second synchronous belt 4211 to move. The second transmission member 422 may extend in the length direction a of the curing device 01. The second transmission member 422 may be a transmission shaft. One end of the second transmission member 422 is fixed to a second transmission wheel 4212 of one of the second transport modules 421, and the other end of the second transmission member 412 is fixed to a second transmission wheel 4212 of the other one of the second transport modules 421. Any one of the second transmission wheels 4212 in one of the second transport modules 421 is connected to the transmission sub-component 43 and moves under the transmission of the transmission sub-component 43.

As illustrated in FIG. 5, in some embodiments, the first transport sub-component 41 further includes a first limiting member 413. The first limiting member 413 is disposed at an outer side of the first transport module 411 and configured to prevent the film 100 from detaching from the first transport module 411. Exemplarily, the first limiting member 413 may be a guide rail, and the guide rail may at least wrap part of the first transport module 411.

The second transport sub-component 42 further includes a second limiting member 423. The second limiting member 423 is disposed on an outer side of the second transport module 421 and configured to prevent the film 100 from detaching from the second transport module 421. Exemplarily, the second limiting member 423 may be a guide rail, and the guide rail may at least wrap part of the second transport module 421.

A first gap is defined between the first limiting member 413 and the first transport module 411, the width of the first gap matches the thickness of the film 100, and the film 100 can move in the first gap, so that the film 100 can be ensured not to detach from the first transport module 411. A second gap is defined between the second limiting member 423 and the second transport module 421, and the width of the second gap matches the thickness of the film 100, so that the film 100 can be ensured not to detach from the second transport module 421.

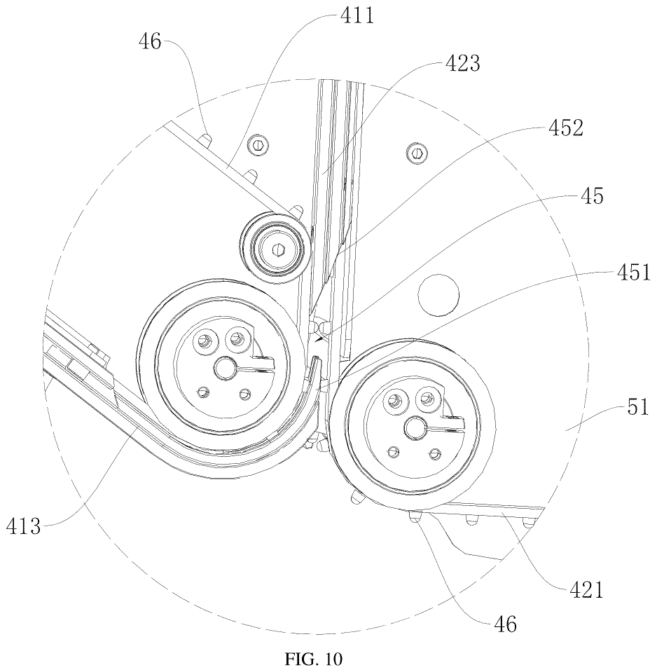

Reference can be made to FIG. 10, the transport component 4 further includes a guiding member 45 disposed between the first transport sub-component 41 and the second transport sub-component 42. The guiding member 45 is configured to guide the film 100 from the first transport sub-component 41 to the second transport sub-component 42 so as to deliver the film 100.

The first transport sub-component 41 and the second transport sub-component 42 converge to each other on one side of the curing component 5 facing towards the powder-dispensing component 3, and the guiding member 45 is formed in a region where the first transport sub-component 41 and the second transport sub-component 42 converge to each other.

The guiding member 45 includes a second guiding member 452. The second guiding member 452 is disposed on one side of the second limiting member 423 close to the first transport sub-component 41. The second guiding member 452 has an inclined surface facing the first transport sub-component 42, and the inclined surface is configured to guide the film 100 to be transferred from the first transport module 411 to the second transport module 421. The second limiting member 423 may abut against or closely abut against the first transport module 411, and the second guiding member 452 is disposed at part of the second limiting member 423 abutting against or opposite to the first transport module 411.

The first transport module 411 and the second transport module 421 rotate in opposite directions, for example, the first transport module 411 rotates clockwise, the film 100 is delivered to a position close to the second transport module 421, and the second transport module 421 rotates counterclockwise. In this way, under the rotation of the first transport module 411 and the second transport module 421 and under the action of the second guiding member 452, the film 100 can be transferred at a position where the first transport module 411 and the second transport module 421 converge to each other, so that the film 100 is transferred from the first transport module 411 to the second transport module 421.

In some embodiments, the guiding member 45 further includes a first guiding member 451. The first guiding member 451 is disposed on one side of the first limiting member 413 close to the second transport sub-component 42. The first guiding member 451 and the second guiding member 452 are disposed in a staggered manner. The first guiding member 451 has an inclined surface extending towards the second transport sub-component 42, and the inclined surface of the first guiding member 451 is configured to guide the film 100 to gradually detach from the first transmission member 412.

In some embodiments, the first guiding member 451 and the second guiding member 452 can be integrally formed, and the first guiding member 451 and the second guiding member 452 are two parts of a single structural member.

The transport component 4 includes the first transport sub-component 41 and the second transport sub-component 42 which are disposed in sections, so that the transport direction of the transport component 4 can be optimized in a limited space, a single-section transport component can be prevented from changing the transmission angle frequently, the transport stability of the film 100 can be improved, the layout of various components is facilitated, the compactness of the whole device can be improved, and the volume of the whole device can be reduced.

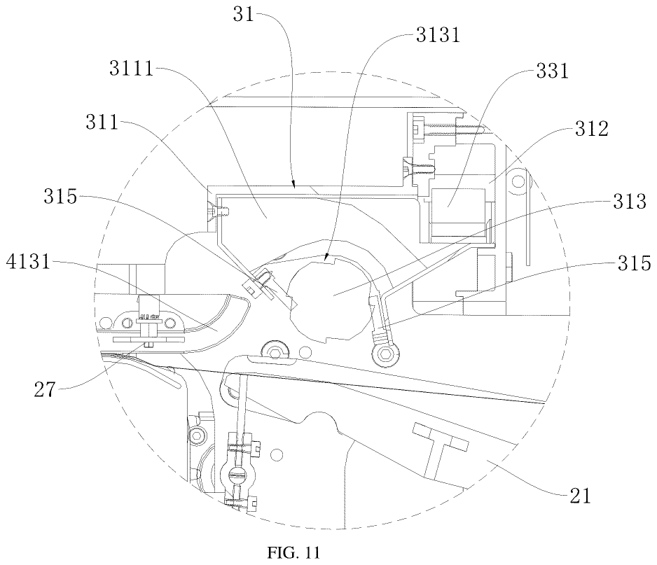

In some embodiments, as illustrated in FIGS. 9 and 11, the first limiting member 413 is further provided with a third guiding member 4131 at one end of the first limiting member 413close to the buffering component 2. One end of the third guiding member 4131 can be curved upward for guiding the film 100 reaching the transport component 4, so that the film 100 passing through the third guiding member 4131 can be gradually brought close to the first transmission member 412, thereby enabling the film 100 to be connected to the transport component 4 and move with the transport component 4. The third guiding member 4131 has a curved guiding surface or an inclined guiding surface. When the third guiding member 4131 has a curved guiding surface, the tangential angle of the curved guiding surface may be set to gradually be decreased.

In some embodiments, the first sensor 43 may be disposed close to the third guiding member 4131 and configured to detect whether there is any film 100 reaching the transport component 4 from the buffer component 2. When the first sensor 43 detects that the film 100 reaches the transport component 4 from the buffer component 2, the second motor 22 controls the swing member 21 to swing downwards to the second position, so that the film 100 forms an arc shape that bends downwards, thereby facilitating the powder-dispensing component 3 to dispense powder onto the film 100.

As illustrated in FIGS. 5 and 8, in some embodiments, the transmission sub-component 43 further includes a first gear 431, a second gear 432, and a third gear 433. The first gear 431 is disposed between the second gear 432 and the third gear 433, and meshes with the second gear 432 and the third gear 433. The first gear 431 is drivingly connected to one of the first transport modules 411 in the first transport sub-component 41, so as to drive the two first transport modules 411 to rotate synchronously. The rotation direction of the first gear 431 is the same as the rotation direction of the first transport modules 411, so that the first transport modules 411 drive the film 100 to gradually approach the second transport sub-component 42. The second gear 432 is drivingly connected to one of the second transport modules 421 in the second transport sub-component 42, so as to drive the two second transport modules 421 to rotate synchronously. The third gear 433 is drivingly connected to the first motor 44.

In the described method, by means of the transmission of the transmission sub-component 43, the precision of the transmission is improved, and there is no need to provide multiple motors to respectively drive the first transport sub-component 41 and the second transport sub-component 42, thereby realizing the simplification of the structure.

FIG. 10 is an enlarged view of FIG. 9 at circle C.

In some embodiments, the transport component 4 is provided with first fitting portions 46, and the first fitting portions 46 are configured to fit with second fitting portions on the film 100, so as to fix the film 100 to the transport component 4.

In some embodiments, first fitting portions 46 are disposed on each of the two first transport modules 411, the second fitting portions are disposed at both lateral edges of the film 100 in the width direction of the film 100, and the first fitting portions 46 can be fitted with the second fitting portions. In this way, the film 100 can be fixed to the transport module 4 through the connection between the first fitting portions 46 and the second fitting portions. Each of the two second transport modules 421 is provided with first fitting portions 46 to fix the film 100 onto the second transport modules 421.

As illustrated in FIGS. 9 and 10, in some embodiments, multiple first fitting portions 46 are disposed on each of the first transport modules 411, and the multiple first fitting portions 46 are disposed at equal intervals. The first fitting portion 46 is configured as a boss, the second fitting portion is configured as a fixing hole. Multiple second fitting portions are provided and disposed at equal intervals. The interval between two adjacent second fitting portions is the same as the interval between two adjacent first fitting portions 46. The first fitting portion 46 passes through the second fitting portion, so as to fix the film 100 on the transport component 4.

Multiple bosses are provided, and the multiple bosses are distributed at intervals in the transport direction of the film 100. One film 100 can be fixed on multiple bosses, so as to improve the fitting degree between the film 100 and the transport component 4. The multiple first fitting portions 46 are disposed at equal intervals, so that the film 100 does not need to be fixed at a specific position of the first transport module 411. Multiple first fitting portions 46 may further be distributed at equal intervals on the second transport module 421.

In order to facilitate the film 100 to be sleeved on the boss, the cross-sectional diameter of the boss may be configured to be gradually decreased from a fixed end of the boss toward a free end of the boss. Exemplarily, the boss may be of a conical structure.

The fixing holes on the film 100 may be configured as waist-shaped holes, thereby further facilitating the film 100 being fixed on the boss. In other embodiments, the fixing holes may also be circular holes.

As illustrated in FIGS. 5 and 8, in other embodiments, the transport component 4 includes an encoding disk 47 and a sixth sensor 48. The encoding disk 47 is provided with multiple gear teeth disposed at intervals at a circumferential edge of the encoding disk 47 in a circumferential direction of the encoding disk 47, and a distance between two adjacent gear teeth is equal to or proportional to a distance between two adjacent bosses. The rotation track of the encoding disk 47 is within a detection range of the sixth sensor 48, and the sixth sensor 48 is configured to detect a rotation distance of the encoding disk 47.

The encoding disk 47 is connected to the first transport sub-component 41 and the second transport sub-component 42, respectively, through the transmission sub-component 43. Specifically, the encoding disk 47 is coaxially disposed with the first gear 431. The first gear 431, the second gear 432, and the third gear 433 have the same rotation radius. The sixth sensor 48 is disposed on one side of the encoding disk 47 and is configured to detect the rotation distance of the encoding disk 47.

When the gear teeth on the encoding disk 47 pass the sixth sensor 48, the sixth sensor 48 generates an excitation signal. The multiple gear teeth on the encoding disk 47 may correspond to the multiple first fitting portions respectively. In some examples, the sixth sensor may further be configured to detect a position of the gear teeth on the encoding disk 47. When the sixth sensor detects the gear teeth, it is determined that the film 100 reaches the connecting position. Specifically, the position of the gear teeth on the encoding disk 47 is detected by the sixth sensor 48, and then it is determined whether the first fitting portion 46 moves to the connecting position, so as to control the transmission of the film 100 to match the second fitting portions on the film 100 with the first fitting portions 46 so as to fix the film accurately on the first transport sub-component 41.

FIG. 11 is an enlarged view of FIG. 3 at circle B.

As illustrated in FIGS. 3 and 11, the powder-dispensing component 3 includes a powder-dispensing mechanism 31, a powder storage mechanism 32, and a powder circulation mechanism33. The powder-dispensing mechanism 31 is disposed above the buffer component 2 and is configured to dust the hot-melt adhesive powder to the film 100 on the buffer component 2. The powder storage mechanism 32 is disposed below the buffer component 2 and configured to store the hot-melt adhesive powder. At least part of the powder circulation mechanism 33 is disposed in the powder storage mechanism 32. When the swing member 21 swings downwards to the second position, the film 100 can form an arc that bends downwards, and the powder-dispensing mechanism 31 spreads the hot-melt adhesive powder on the film 100, so that the hot-melt adhesive powder is more evenly distributed on the surface of the film 100, and the hot-melt adhesive powder better covers the design on the film 100.

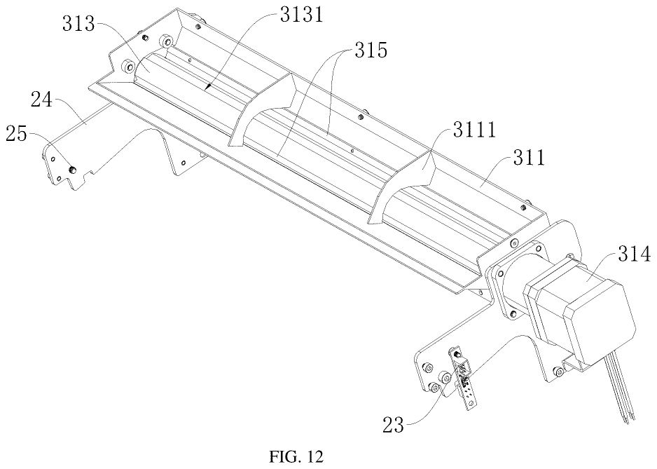

FIG. 12 is a schematic structural view of a powder-dispensing mechanism provided in the present disclosure.

As illustrated in FIGS. 3, 11 and 12, further, the powder-dispensing mechanism 31 includes a powder-dispensing bin 311, a powder-dispensing roller 313, and a third motor 314. The powder-dispensing bin 311 is disposed above the buffer component 2, and two ends of the powder-dispensing bin 311 are fixed to the bracket 24. The powder-dispensing roller 313 is disposed in the powder-dispensing bin 311 and extends in a length direction of the powder-dispensing bin 311. One end of the powder-dispensing roller 313 is rotatably connected to one of the installation plates 241. An output shaft of the third motor 314 passes through the other one of installation plates 241 and is drivingly connected to the other end of the powder-dispensing roller 313. The third motor 314 is configured to drive the powder-dispensing roller 313 to rotate so as to drive the powder-dispensing bin 311 to enable the powder-dispensing bin 311to dust the hot-melt adhesive powder downwards onto the film 100.

The powder-dispensing bin 311 is configured to store the hot-melt adhesive powder transferred from the powder storage mechanism 32 by the powder circulation mechanism 33. A cross section of the powder-dispensing bin 311 is substantially V-shaped, so that the hot-melt adhesive powder in the powder-dispensing bin 311 can better slide to the bottom of the powder-dispensing bin 311. The bottom of the powder-dispensing bin 311 defines a powder-dispensing port, and the powder-dispensing port is used for discharging the hot-melt adhesive powder, and the powder-dispensing port extends in the length direction of the powder-dispensing bin 311. It can be understood that, the length of the powder-dispensing port is not less than the width of the film 100, so as to ensure that the hot-melt adhesive powder can cover various positions in the width of the film 100.

Multiple reinforcing ribs 3111 are provided at intervals in the powder-dispensing bin 311. Two ends of each of the reinforcing ribs 3111 are respectively connected to two side walls of the powder-dispensing bin 311 in the width direction of the powder-dispensing bin 311.

In some embodiments, the powder-dispensing mechanism 31 is linked to the printer 02. After the film 100 reaches a specific position, the third motor 314 works for a set time to ensure that the powder-dispensing mechanism 31 can spread a sufficient amount of hot-melt adhesive powder, and after the set time, the third motor 314 stops working. This setting can precisely control the amount of the hot-melt adhesive powder on the film 100. In addition, the amount of the hot-melt adhesive powder to be spread can be adjusted through printing parameters, for example, when the number of the PASSES is great and the picture is large, the amount of the hot-melt adhesive powder to be spread is increased.

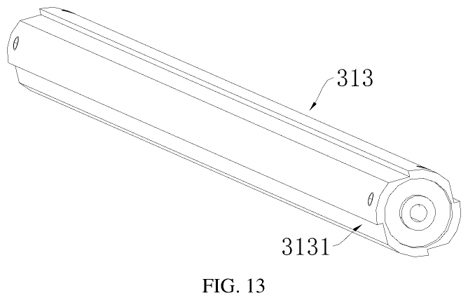

FIG. 13 is a schematic view of a powder-dispensing roller provided in the present disclosure.

As illustrated in FIGS. 12 and 13, the third motor 314 is drivingly connected to the powder-dispensing roller 313, and is configured to drive the powder-dispensing roller 313 to rotate, so as to spread the hot-melt adhesive powder in the powder-dispensing bin 311 out through the powder-dispensing port, thereby spreading the hot-melt adhesive powder downwards onto the film 100. At least one powder groove 3131 is defined on the surface of the powder-dispensing roller 313, the powder groove 3131 is used to contain the hot-melt adhesive powder, and the powder groove 3131 extends in an axial direction of the powder-dispensing roller 313. When the powder-dispensing roller 313 rotates, the powder groove 3131 can carry out the hot-melt adhesive powder in the powder-dispensing bin 311, so as to spread the hot-melt adhesive powder out through the powder-dispensing port, thereby improving the uniformity of the distribution of the hot-melt adhesive powder on the film 100.

As illustrated in FIG. 13, in some embodiments, multiple powder grooves 3131 are defined on a cylindrical surface of the powder-dispensing roller 313, and the multiple powder grooves 3131 are evenly disposed at intervals along the cylindrical surface of the powder-dispensing roller 313, so as to improve the powder-dispensing efficiency.

As illustrated in FIG. 11 and FIG. 12, in some embodiments, the powder-dispensing mechanism 31 further includes a powder-scraping member 315 disposed in a region in the powder-dispensing bin 311 close to the powder-dispensing port. The powder-scraping member 315 is configured to contact the powder-dispensing roller 313 to scrape the hot-melt adhesive powder in the powder groove 3131 when the powder-dispensing roller 313 rotates so as to spread the hot-melt adhesive powder out of the powder-dispensing port.

In some embodiments, two powder-scraping members 315 are provided. The two powder-scraping members 315 are respectively provided at two ends of the powder-dispensing port, and the two powder-scraping members 315 face opposite directions and are located at two sides of the powder-dispensing roller 313 in the axial direction of the powder-dispensing roller 313. The two powder-scraping members 315 both abut against the powder-dispensing roller 313.

The two powder-scraping members 315 are disposed on two sides of the axial direction of the powder-dispensing roller 313, and a distance between the two powder-scraping members 315 is no greater than the width of the powder-dispensing roller 313. When the powder-dispensing roller 313 rotates, the two powder-scraping members 315 can sweep out the hot-melt adhesive powder in the powder groove 3131, so that the hot-melt adhesive powder can fall onto the film 100.

The two powder-scraping members 315 are obliquely disposed, and an inclined direction of each of the powder-scraping members 315 is opposite to the rotation direction of the powder-dispensing roller 313. This arrangement enables the two powder-scraping members 315 to be inserted into the powder groove 3131 when the powder-dispensing roller 313 rotates, and enables the hot-melt adhesive powder in the powder groove 3131 to be effectively carried out in a direction opposite to the rotation direction of the powder-dispensing roller 313. Exemplarily, the powder-dispensing roller 313 rotates counterclockwise, and one powder-scraping 315 is disposed in front of the powder-dispensing roller 313 and is inclined downwards, and the other powder-scraping 316 is disposed behind the powder-dispensing roller 313 and is inclined upwards.

The powder-scraping member 315 is a brush, and the brush includes a soft portion in contact with the powder-dispensing roller 313, and the soft portion is deformable as the powder-dispensing roller 313 rotates so as to scrape the hot-melt adhesive powder in the powder groove 3131. In other embodiments, the powder-scraping 315 may be an element made of a soft material, such as a silicone rod.

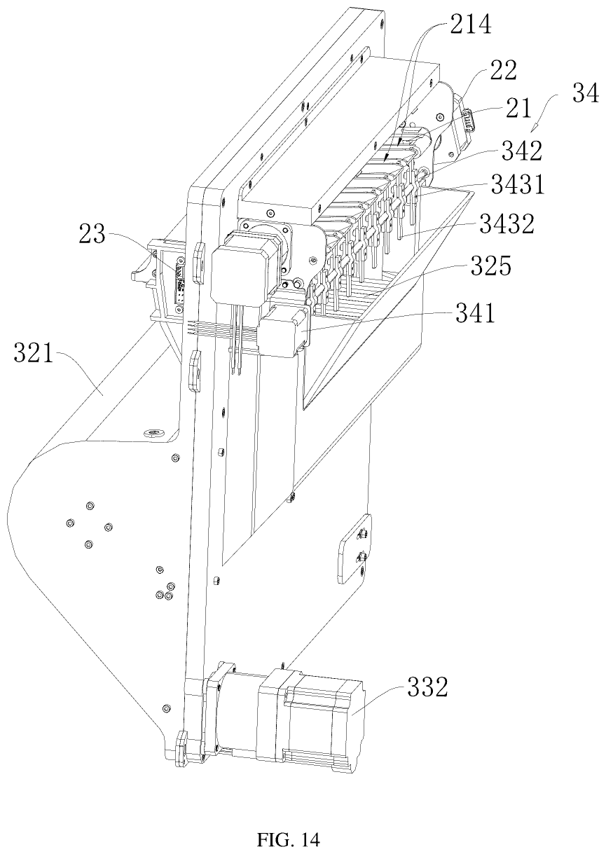

FIG. 14 is a schematic structural view of the powder-dispensing component provided in the present disclosure.

As illustrated in FIGS. 3, 6 and 14, the powder-dispensing component 3 includes the powder storage mechanism 32, which is disposed below the buffer component 2 and is configured to store and recovery the hot-melt adhesive powder.

The powder storage mechanism 32 includes a powder recovery chamber 321a1 and a powder storage chamber 321b1 which are in communication. The powder recovery chamber 321a1 is closer to the buffer component 2 than the powder storage chamber 321b1. At least part of the buffer component 2 is disposed in the powder recovery chamber 321a1 and the buffer component 2 is swingable in the powder recovery chamber 321a1.

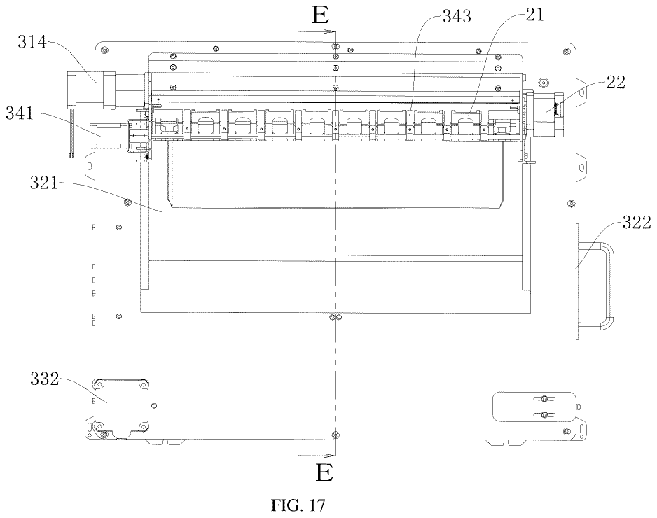

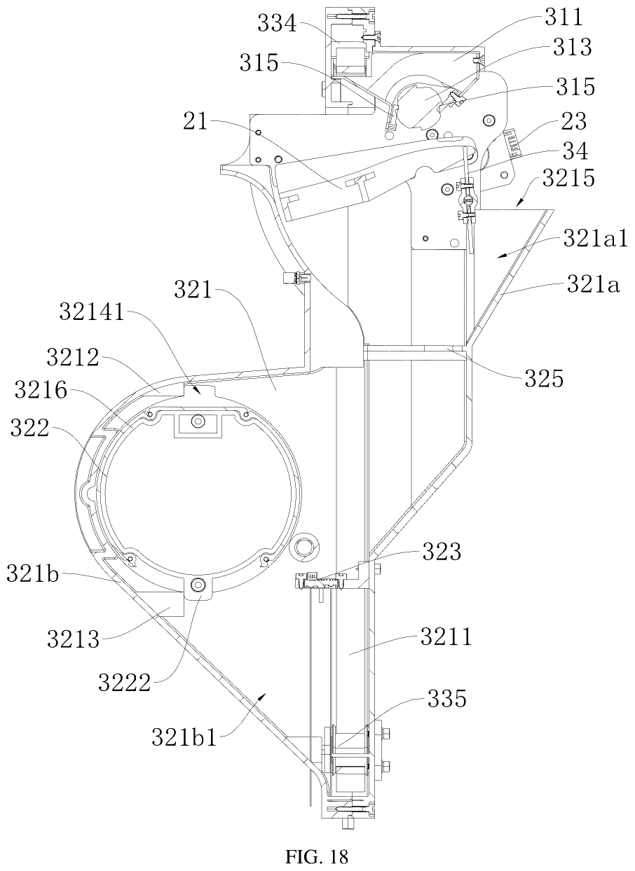

FIG. 17 is a schematic structural view of the powder-dispensing component from a second perspective provided in the present disclosure, and FIG. 18 is a cross-sectional view of FIG. 17, taken along E-E direction.

In conjunction with what are illustrated in FIGS. 3 and 18, the powder-dispensing mechanism 31 is correspondingly disposed above the powder recovery chamber 321a1, and the buffer component 2 is at least partially disposed in the powder recovery chamber 321a1 and is swingable in the powder recovery chamber 321a1, so that when the powder-dispensing mechanism 31 spreads the hot-melt adhesive powder to the film 100, excess hot-melt adhesive powder can enter the powder recovery chamber 321a1. The powder recovery chamber 321a1 is in communication with the powder storage chamber 321b1, and the hot-melt adhesive powder collected by the powder recovery chamber 321a1 can fall directly into the powder storage chamber 321b1 without requiring frequent cleaning on the powder recovery chamber 321a1, thereby improving the usage experience.

The powder storage mechanism 32 includes a powder storage bin 321. The powder storage bin 321 is configured to store the hot-melt adhesive powder. The powder recovery chamber 321a1 and the powder storage chamber 321b1 are defined in the powder storage bin 321. The powder storage bin 321 defines a powder recovery port 3215 facing upwards, and the powder recovery port 3215 communicates the powder recovery chamber 321a1 and the first accommodating chamber 16. Excess hot-melt adhesive powder on the film 100 or hot-melt adhesive powder dropped from the powder-dispensing mechanism 31 can be recycled through the powder recovery port 3215 to the powder storage bin 321, facilitating recovery and utilization of the hot-melt adhesive powder.

An upper portion of the powder storage bin 321 is V-shaped, the cross section of the upper portion of the powder storage bin 321 is gradually increased from down to up. In this way, it can be ensured that the powder recovery port 3215 is large enough to receive the hot-melt adhesive powder falling from the powder-dispensing mechanism 31, and the recycled hot-melt adhesive powder can quickly slide down to the bottom of the powder storage bin 321 along the inclined side wall of the powder storage bin 321.

The powder storage bin 321 includes a powder recovery portion 321a and a powder storage portion 321b, and the powder recovery portion 321a is disposed above the powder storage portion 321b. The powder recovery portion 321a defines the powder recovery port 3215 at an upper end of the powder recovery portion 321a. A chamber width of at least part of the powder recovery portion 321a is gradually decreased from up to down, and a chamber width of at least part of the powder storage portion 321b is gradually decreased from up to down. In this way, even if the volume of the hot-melt adhesive powder is small, the hot-melt adhesive powder can be easily transferred. The powder recovery chamber 321a1 is defined in the powder recovery portion 321a, and the powder storage chamber 321b1 is defined in the powder storage portion 321b.

Further, a grating 325 is disposed in the powder storage bin 321 at a position close to the powder recovery port 3215. By providing the grating 325, the hot-melt adhesive powder in the powder storage bin 321 can be avoided from being taken away by the airflow generated by the swing of the swing member 21 when there is a large amount of hot-melt adhesive powder in the powder storage bin 321.

The powder storage mechanism 32 includes a powder filling bin 322. The powder filling bin 322 is rotatably and slideably (or pullably) mounted in the powder storage bin 321, and the powder filling bin 322 is configured to store hot-melt adhesive powder. The powder filling bin 322 has a powder discharge port, through which the hot-melt adhesive powder in the powder filling bin 322 can be poured into the powder storage bin 321.

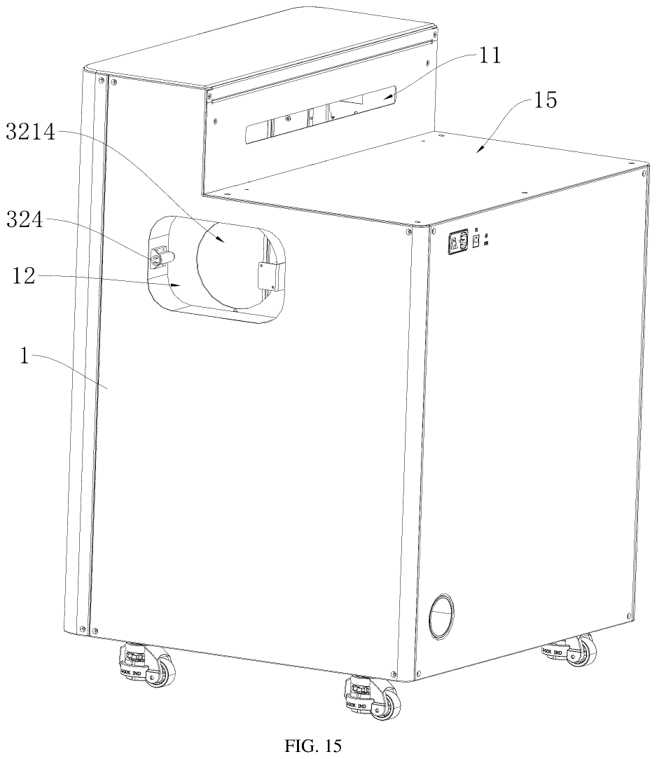

FIG. 15 is a schematic structural view of the curing device from a second perspective provided in the present disclosure.

As illustrated in FIGS. 3 and 15, a first through hole 3214 is defined in a side wall of the powder storage bin 321, and the powder filling bin 322 passes through the first through hole 3214.

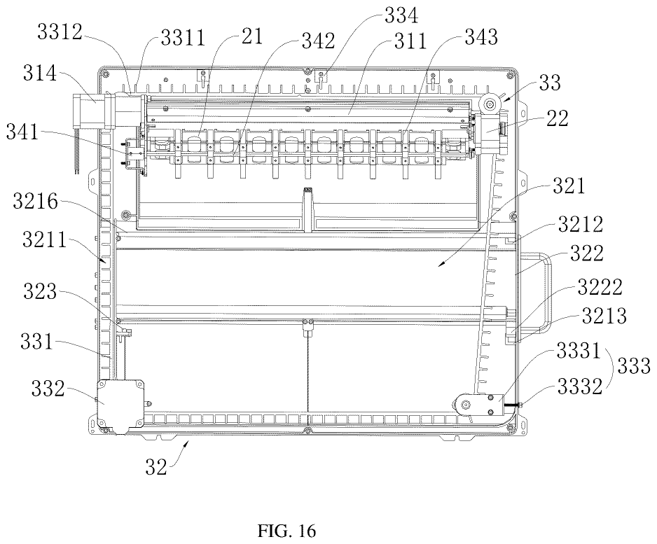

FIG. 16 is a schematic view showing an interior structure of the powder-dispensing component provided in the present disclosure. FIG. 17 is a schematic structural view of the powder-dispensing component provided in the present disclosure from a second view. FIG. 18 is a cross-sectional view of FIG. 17, taken along E-E direction.

As illustrated in FIGS. 16-18, the powder filling bin 322 is provided with a third limiting protrusion 3222 on a side wall of the powder filling bin 322, and a protruding direction of the third limiting protrusion 3222 is the same as an orientation of the powder discharge port of the powder filling bin 322. A first notch 32141 is defined in an upper portion of the first through hole 3214, and the third limiting protrusion 3222 is adapted to the first notch 32141.

The powder storage bin 321 is provided with a first limiting protrusion 3212 and a second limiting protrusion 3213 on an inner wall of the powder storage bin 321 at a position close to the first through hole 3214. The first limiting protrusion 3212 is disposed above the first through hole 3214, and the second limiting protrusion 3213 is disposed below the first through hole 3214.

The powder filling bin 322 has a first position and a second position relative to the powder storage bin 321. When the powder filling bin 322 is at the first position, the first notch 32141 and the third limiting protrusion 3222 are disposed correspondingly, and the third limiting protrusion 3222 abuts against the first limiting protrusion 3212. The powder filling bin 322 rotates until the third limiting protrusion 3222 abuts against the first limiting protrusion 3212, and the powder filling bin 322 can be pulled out from the powder filling bin 321. When the powder filling bin 322 is at the second position, the third limiting protrusion 3222 abuts against the second limiting protrusion 3213, and the powder discharge port of the powder filling bin 322 faces downwards, so that the hot-melt adhesive powder in the powder filling bin 322 can be transferred to the powder storage bin 321.

In some embodiments, the first limiting protrusion 3212 and the second limiting protrusion 3213 are disposed at two ends of the first through hole 3214 in a radial direction of the first through hole 3214. The second limiting protrusion 3213 limits the third limiting protrusion 3222 to the bottom of the first through hole 3214. In this way, when the powder filling bin 322 pours the hot-melt adhesive powder into the powder filling bin 321, the powder discharge port of the powder filling bin 322 faces downwards, ensuring that the hot-melt adhesive powder in the powder filling bin 322 can fall into the powder filling bin 321 completely.

When hot-melt adhesive powder is added, the powder filling bin 322 is rotated to a position where the third limiting protrusion 3222 abuts against the first limiting protrusion 3212, the powder filling bin 322 is pulled out, the hot-melt adhesive powder is added into the powder filling bin 322, then the powder filling bin 322 is inserted into the powder storage bin 321, and the powder filling bin 322 is rotated to pour the hot-melt adhesive powder in the powder filling bin 322 into the powder storage bin 321. Repeat this process until the powder-dispensing operation is completed.

A sleeve 3216 is also disposed in the powder storage bin 321, and the sleeve 3216 is configured to support the powder storage bin 322. The sleeve 3216 is rotatable relative to the powder storage bin 321, and the sleeve 3216 abuts against to an outer side surface of the lower side of the powder storage bin 322.

A fourth sensor 323 is disposed in the powder storage bin 321, and the fourth sensor 323 is configured to detect a volume of the hot-melt adhesive powder in the powder storage bin 321. When the volume of the hot-melt adhesive powder in the powder storage bin 321 is less than a certain value, the fourth sensor 323 will send an alarm to prompt the powder to be added.

Multiple fourth sensors 323 may be disposed on different heights inside the powder storage bin 321 so that different powder adding signals can be generated.

As illustrated in FIG. 15, further, a powder filling port 12 is defined on the housing 1, the powder filling bin 322 is disposed corresponding to the powder filling port 12, and the powder filling port 12 is used for allowing the powder filling bin 322 to be taken out. The powder filling port 12 is covered by and connected to a powder filling cover 6 for sealing the powder filling port 12 to prevent the powder filling bin 322 from being touched by mistake.

The powder filling cover 6 may be movably connected to the housing 1, or one side of the powder filling cover 6 may be rotatably connected to the housing 1 through a connecting member. A rebound member 324 is disposed on an outer wall of the powder storage bin 321, and the other side of the powder filling cover 6 can be connected to the powder storage bin 321 via the rebound member 324, so as to facilitate opening and closing of the powder filling cover 6, and facilitate taking and placing of the powder storage bin 322.

In this embodiment, 2 kilogram (kg) of hot-melt adhesive powder can be added to the powder filling bin 322 at a time, and the powder storage bin 321 can accommodate 4 kg of hot-melt adhesive powder. The powder storage bin 321 has a large capacity, which can reduce the frequency of powder filling.

As illustrated in FIGS. 3, 6 and 18, the powder-dispensing component 3 includes a powder circulation mechanism 33, the powder circulation mechanism 33 is disposed in the powder-dispensing mechanism 31 and the powder storage mechanism 32. The powder circulation mechanism 33 is configured to transport the hot-melt adhesive powder in the powder storage mechanism 32 to the powder-dispensing mechanism 31.

The powder circulation mechanism 33 includes a powder circulation synchronous belt 331, a transmission structure 335, and a fourth motor 332. The powder circulation synchronous belt 331 forms a circulation loop between the powder-dispensing mechanism 31 and the powder storage mechanism 32.

The transmission structure 335 includes a driving wheel 3351 and multiple driven wheels 3352, and the driving wheel 3351 and the multiple driven wheels 3352 are respectively disposed in a circulation direction of the power circulation synchronous belt 331. The driving wheel 3351 and the multiple driven wheels 3352 are all drivingly connected to the power circulation synchronous belt 331, and the multiple driven wheel 3352s are configured to change a transmission direction of the power circulation synchronous belt 335.

The fourth motor 332 is drivingly connected to the driving wheel 3351, and is configured to drive the driving wheel 3351 to rotate to drive the power circulation synchronous belt 331 to cyclically move along the powder-dispensing mechanism 31 and the powder storage mechanism 32, so as to transport the hot-melt adhesive powder in the powder storage mechanism 32 to the powder-dispensing mechanism 31, thereby realizing powder-dispensing, recovery, and reuse of the hot-melt adhesive powder.

The powder circulation synchronous belt 331 is drivingly connected to the driving wheel 3351 and the multiple driven wheels 3352 to form a circulation loop between the powder-dispensing mechanism 31 and the powder storage mechanism 32. Part of the powder circulation synchronous belt 331 is disposed above the powder-dispensing mechanism 31, and part of the powder circulation synchronous belt 331 is disposed in the powder storage mechanism 32. The powder circulation synchronous belt 331 is configured to carry part of hot-melt adhesive powder out of the powder storage mechanism 32 to transport the hot-melt adhesive powder to the powder-dispensing component 3.

As illustrated in FIG. 16, the powder circulation synchronous belt 331 includes a body 3312 and multiple protrusions 3311 disposed on an outer side of the body 3312. The body 3312 is drivingly connected to the transmission structure 335 on an inner side of the body 3312. Multiple protrusions 3311 are disposed at intervals. A space for powder is defined between two adjacent protrusions 3311, and the space for powder is used for containing hot-melt adhesive powder.

Part of the power circulation synchronous belt 331 located in the power storage mechanism 32 extends to the bottom of the power storage bin321, and a groove through which the power circulation synchronous belt 331 passes is defined at the bottom of the power storage bin 321. During the circulation movement of the power circulation synchronous belt 331, the protrusions 3311 can move along the groove in the power storage bin321 carrying the hot-melt adhesive powder in the power storage bin321, and rise to the powder-dispensing compartment 311.

As illustrated in FIG. 6, the powder circulation mechanism 33 further includes a powder unloading member 334. The powder unloading member 334 is disposed above the powder-dispensing bin 311 of the powder-dispensing mechanism 31 and located on an outer side the powder circulation synchronous belt 311. At least one powder unloading member 334 is provided in a length direction of the powder-dispensing bin 311. During the movement of the powder circulation synchronous belt 331, the powder unloading member 334 is used to unload the hot-melt adhesive powder carried on the powder circulation synchronous belt 331 to allow the hot-melt adhesive powder fall into the powder-dispensing bin 311.

The powder unloading member 334 may cover most of the powder circulation mechanism 33 in the powder-dispensing bin 311, so that the hot-melt adhesive powder can be evenly transported to the powder-dispensing bin 311, enabling the hot-melt adhesive powder to be adhered onto the film 100 uniformly. In some examples, multiple powder unloading members 334 are disposed at intervals in the length direction of the powder-dispensing bin 311, which not only can enable the hot-melt adhesive powder to be evenly transported to the powder-dispensing bin 311, but also can reduce the friction force between the powder unloading members 334 and the powder circulation mechanism 33.

As illustrated in FIGS. 6 and 16, a powder guiding groove 3211 is disposed on one side of the powder storage bin 321, the powder guiding groove 3211 extends in a height direction of the powder storage bin 321, and the powder circulation synchronous belt 331 is disposed in the powder guiding groove 3211 to drive the hot-melt adhesive powder to rise from the powder storage bin 321 to the powder-dispensing bin 311.

The powder circulation mechanism 33 further includes a tensioning mechanism 333. The tensioning mechanism 333 passes through the powder storage mechanism 32, and is rotatably connected to the powder circulation synchronous belt 331. The tensioning mechanism is configured to adjust a tensioning degree of the powder circulation synchronous belt 331.

In some embodiments, the tensioning mechanism 333 includes a tensioning member 3331 and a tensioning screw 3332. The tensioning member 3331 is disposed in the powder storage bin 321, and the powder circulation synchronous belt 331 passes through the tensioning member 3331. One of the multiple driven wheels 3352 of the power circulation synchronous belt 331 is rotatably connected to the tensioning member 3331. One end of the tensioning screw 3332 passes through one side wall of the powder storage bin 321 and is connected to the tensioning member 3331. By adjusting the length by which the tensioning screw 3332 is screwed into the powder storage bin 321, the tensioning degree of the powder circulation synchronous belt 331 can be adjusted, so that the powder circulation synchronous belt 331 can be ensured to operate normally.

As illustrated in FIGS. 14 and 16, the powder-dispensing component 3 further includes a powder tapping mechanism 34 disposed between the powder-dispensing mechanism 31 and the powder storage mechanism 32. The powder tapping mechanism 34 is located in the transport path of the film 100. The powder tapping mechanism 34 is configured to tap the film 100 dusted with the hot-melt adhesive powder, so as to shake off the hot-melt adhesive powder that is not adhered to the film 100.

The powder tapping mechanism 34 includes a fifth motor 341, a rotating shaft 342, and at least one tapping member 343 disposed on the rotating shaft 342. The fifth motor 341 is drivingly connected to the rotating shaft 342, and is configured to drive the rotating shaft 342 to rotate. When the rotating shaft 342 rotates, the at least one tapping member 343 can rotate to a back of the film 100 on the buffer component 2 and contact the back of the film 100, so as to tap the film 100, thereby shaking off excessive hot-melt adhesive powder on the film 100, and improving the utilization rate of the hot-melt adhesive powder.

When the powder tapping mechanism 34 operates, the fifth motor 341 cyclically rotates forward and reverse, enabling the at least one tapping member 343 to tap on the film 100 intermittently.

In some embodiments, multiple tapping members 343 are provided, and the multiple tapping members 343 are disposed at intervals in an axial direction of the rotating shaft 342, so as to cover a wider range of the film 100, and more effectively shake off excessive hot-melt adhesive powder on the film 100.

As illustrated in FIG. 14, the powder tapping mechanism 34 is disposed on one side of the buffer component 2 facing away from the feeding port 11 and is fixed below the buffer component 2. One end of the swing member 21 facing away from the feeding port 11 defines an avoidance groove 214, a groove opening of the avoidance groove 214 faces towards a transport direction of the film 100. Multiple avoidance grooves 214 are defined along the swing member 21 at intervals in the length direction a of in the curing device 01. The multiple avoidance grooves 214 and the multiple tapping members 343 are disposed correspondingly. The tapping member 343 can rotate to be inserted into the avoidance groove 214, and can tap the back of the film 100 disposed on the buffer component 2, so as to shake off the hot-melt adhesive powder that is not adhered to the film 100.

As illustrated in FIGS. 14 and 16, the tapping member 343 includes a clamp 3431 and a flexible member 3432 fixed to one end of the clamp 3431. The clamp 3431 is fixed to the rotating shaft 342, and the flexible member 3432 may be disposed at one end of the clamp 3431 or at both ends of the clamp 3431. Exemplarily, the flexible member 3432 may be a silica gel member. The silica gel member has a certain strength, which not only can produce an effective tapping effect on the film 100, but also cannot scratch the film 100.

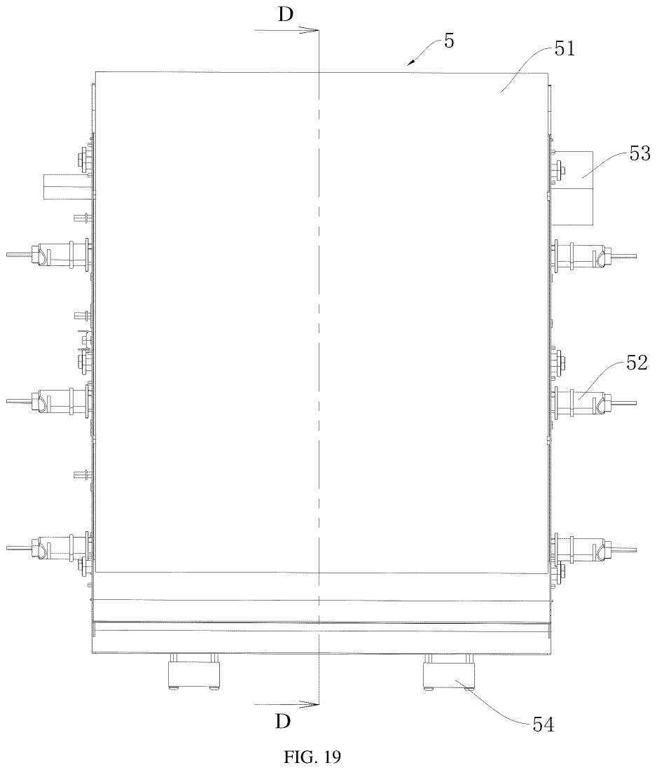

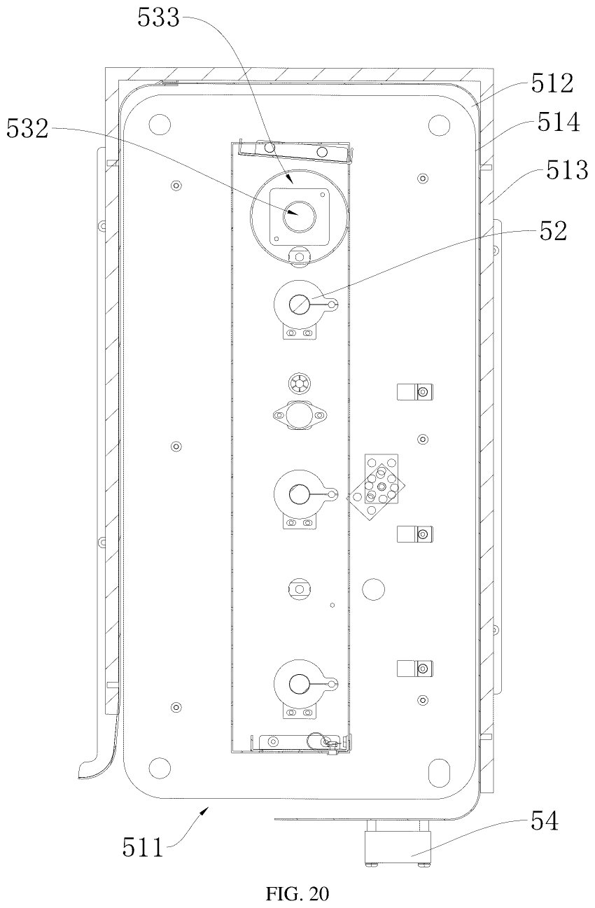

FIG. 19 is a schematic structural view of the curing component provided in the present disclosure, and FIG. 20 is a cross-sectional view of FIG. 19, taken along D-D direction.

As illustrated in FIGS. 3, 19, and 20, the curing component 5 includes a box 51, a heating member 52, and an exhaust structure 53. An air supply port 511 is defined at the bottom of the box 51, and the transport component 4 at least surrounds part of the box 51. At least one heating component 52 is provided, the at least one heating component 52 is disposed in the box 51, and the at least one heating component 52 is configured to generate heat. The exhaust structure 53 is in communication with an interior of the box 51. The exhaust structure 53 is configured to be connected to an external exhaust gas purification device, and is configured to drive air flow in the box 51, so as to discharge the exhaust gas generated in the box 51 to the external exhaust gas purification device.

When the film 100 passes through the curing component 5, the film 100 moves between the box 51 and the at least one heating member 52. In the curing process, the film 100 can surround the box 51 to sequentially pass through a front surface, an upper surface, and a rear surface of the box 51, so that the film 100 can be completely cured, thereby shortening the curing time and improving the curing effect.

As illustrated in FIGS. 3 and 8, the exhaust structure 53 includes an exhaust fan 531, a first exhaust pipe 532, and a second exhaust pipe 533.The exhaust fan 531 is disposed above the box 51 and is in communication with the interior of the box 51. The first exhaust pipe 532 is in communication with an air outlet of the exhaust fan 531. One end of the second exhaust pipe 533 is in communication with the first exhaust pipe 532, and the other end of the second exhaust pipe 533 is in communication with the exterior exhaust gas purification device. An inner diameter of the first exhaust pipe 532 is less than an inner diameter of the second exhaust pipe 533, so that the Bernoulli fluid is formed in the exhaust structure 53, and the exhaust speed of the exhaust gas in the body 51 is improved.

The first exhaust pipe 532 and the second exhaust pipe 533 are axially connected, and are disposed in the box 5 of curing component, thereby improving the compactness of the curing device 01 to some extent, and reducing the volume of the curing device 01.

At least one heating member 52 is provided, and the at least one heating member 52 is disposed in the box 51 and is configured to dry the film 100 passing through the curing component 5.

Multiple heating members 52 may be provided, and the multiple heating members 52 may be spaced apart from each other in a height direction of the housing 51. The heating members 52 are distributed along the height direction, which reduces the volume of the whole device to some extent.

The multiple heating members 52 may be evenly spaced or unevenly spaced. The multiple heating members 52 may be set to have the same power or different powers, which may be specifically determined according to a design or material to be dried.

In some embodiments, as illustrated in FIGS. 8 and 19, the exhaust structure 53 includes a fan 54, a first exhaust pipe 532, and a second exhaust pipe 533. The fan 54 is disposed below the box 51 and can supply air into the box 51. By supplying air into the box 51 by the fan 54, the convection speed in the box 51 can be accelerated, and the exhaust gas generated in the box 51 can be discharged into the exhaust gas purification device more quickly through the first exhaust pipe 532 and the second exhaust pipe 533.

As illustrated in FIGS. 8 and 20, the curing unit 5 further includes an isolation box 55, and the wall of the isolation box 55 is in a mesh shape. The heating member 52 is disposed in the isolation box 55, so that the heating member 52 is isolated from the film 100. The isolation box 55 of a mesh structure does not affect a heating effect of the heating member 52, and can ensure a drying effect of the film 100.

As illustrated in FIG. 20, an aluminum foil layer 512 and a thermal insulation layer 513 are disposed on a side wall of the box 51. The aluminum foil layer 512 and the thermal insulation72 layer 513 can reduce heat loss in the curing component 5, and prevent the heat generated by the curing component 5 from affecting other components of the curing device 01. A mirror layer 514 is formed on an inner wall of the housing 51. Thermal radiation is generated on the hot air by the mirror layer 514, so that heat loss can be reduced.

In this embodiment, as illustrated in FIGS. 19 and 20, three heating members 52 are disposed in the box 51 to meet the drying requirements of most DTF printed pieces. Two fans 54 are provided, and the two fans 54 are disposed side by side along the bottom of the box 51 to satisfy the requirement of gas circulation in the box 51.

Multiple cooling fans are further connected to an outer side of the box 51, and exhaust directions of the cooling fans may face the second transport module 421, so as to accelerate flow speed of air on the surface of the second transport module 421, thereby improving cooling effect of the second transport module 421.

It should be understood that, for those skilled in the art, equivalent replacements or modifications may be made according to the technical solution and the application concept of the present disclosure, and all these equivalent modifications or replacements fall within the scope defined by the claims of the present disclosure.

While the disclosure has been described with reference to a few exemplary embodiments, it is to be understood that the terminologies used herein are for the purpose of illustrating and exemplifying, rather than limiting. Since the disclosure may be embodied in many forms without departing from the spirit or essence of the application, it can be understood that the above-described embodiments are not limited by any of the foregoing details, but should be construed broadly within the spirit and scope as defined by the appended claims. Therefore, all changes and modifications falling within the scope of the claims or their equivalents are to be embraced by the appended claims.

What is claimed is:

1. A curing device, comprising: a housing, and a powder-dispensing component, a transport component, and a curing component which are disposed within the housing;
wherein the housing defines a feeding port, and the feeding port is configured to allow a film to enter the housing through the feeding port;
wherein the powder-dispensing component is disposed between the feeding port and the transport component, and the powder-dispensing component is configured to contain hot-melt adhesive powder and dust the hot-melt adhesive powder to the film;
wherein the transport component is configured to transport the film; and
wherein the curing component is disposed in a transport path of the film and is configured to cure the film to melt the hot-melt adhesive powder on the film.

2. The curing device of claim 1, wherein the feeding port is disposed on one side of the housing in a width direction of the curing device, the powder-dispensing component extends in a height direction of the curing device and a length direction of the curing device, the curing component is disposed on one side of the powder-dispensing component in the width direction of the curing device, and the curing component and the feeding port are located on a same side of the curing device in the width direction of the curing device.

3. The curing device of claim 2, wherein the housing defines an installation space for installing an external device on an outer side the housing, the housing defines a first accommodating chamber located in parallel with the installation space in the width direction of the curing device in the housing, the housing defines a second accommodating chamber located below the first accommodating chamber and the installation space in the height direction of the curing device in the housing, the feeding port is in communication with the first accommodating chamber and the installation space; part of the powder-dispensing component is disposed in the first accommodating chamber, another part of the powder-dispensing component is disposed in the second accommodating chamber; and the curing component is disposed in the second accommodating chamber and disposed below the installation space.

4. The curing device of claim 3, wherein the curing device further comprises a take-up component, the take-up component is disposed at a bottom of the housing, the take-up component defines a take-up chamber and a take-up port communicating the take-up chamber with the second accommodating chamber, the take-up port is opposite to the transport component disposed below the curing component, and the film on the transport component is allowed to enter the take-up chamber through the take-up port.

5. The curing device of claim 2, wherein the transport component comprises a first transport sub-component, a second transport sub-component, a transmission sub-component, and a first motor, the first motor is drivingly connected to the transmission sub-component, and the transmission sub-component is drivingly connected to the first transport sub-component and the second transport sub-component; and the first transport sub-component is arranged close to the powder-dispensing component, the second transport sub-component at least encircles part of the curing component, and during transport of the film by the transport component, the film is transferrable from the first transport sub-component to the second transport sub-component.

6. The curing device of claim 5, wherein the first transport sub-component comprises two first transport modules and a first transmission member which is drivingly connected to the two first transport modules, and the two first transport modules are spaced apart in the length direction of the curing device; and the second transport sub-component comprises two second transport modules and a second transmission member which is drivingly connected to the two second transport modules, and the two second transport modules are spaced apart in the length direction of the curing device.

7. The curing device of claim 6, wherein the first transport sub-component further comprises a first limiting member, the first limiting member is disposed on an outer side of each first transport module, and the first limiting member is configured to prevent the film from detaching from each first transport module; and the second transport sub-component further comprises a second limiting member, the second limiting member is disposed on an outer side each second transport module, and the second limiting member is configured to prevent the film from detaching from each second transport module.

8. The curing device of claim 7, wherein the transport component further comprises a first guiding member and a second guiding member, the first guiding member is disposed on one side of the first limiting member close to a second transport sub-component, the first guiding member has an inclined surface facing the second transport sub-component, and the inclined surface of the first guiding member is configured to guide the film to detach from the first transmission member; and the second guiding member is disposed on one side of the second limiting member close to a first transport sub-component, the second guiding member has an inclined surface facing the first transport sub-component, and the inclined surface of the second guiding member is configured to guide the film to be transferred from the first transport module to the second transport module.

9. The curing device of claim 1, further comprising:
a buffer component disposed within the housing;
wherein the buffer component is disposed between the feeding port and the transport component and passes through part of the powder-dispensing component, the buffer component is configured to guide the film entering through the feeding port to the transport component; and
wherein the buffer component extends along a length direction of the curing device.

10. The curing device of claim 9, wherein the buffer component comprises a bracket and a swing member disposed on the bracket, the bracket is fixed in the housing, and the swing member is disposed opposite to the feeding port; and the swing member is swingable relative to the bracket to be swingable within a range between a first position and a second position;
wherein the swing member has a feeding surface, the feeding surface has a changed inclination angle; and when the swing member is at the first position, two ends of the swing member corresponding to the feeding surface are respectively close to the feeding port and the transport component, and when the swing member is at the second position, the feeding surface is relatively far away from the feeding port.

11. The curing device of claim 10, wherein the feeding surface comprises a first transport sub-surface and a second transport sub-surface connected to each other, and the first transport sub-surface and the second transport sub-surface are curved surfaces; and a tangential angle of the first transport sub-surface is gradually increased and a tangential angle of the second transport sub-surface is gradually decreased in a width direction of the swinging member.

12. The curing device of claim 1, wherein the transport component comprises a synchronous belt, the transport component is provided with a first fitting portion on the synchronous belt, and the first fitting portion is configured to fit with a second fitting portion on the film, to fix the film to the transport component; and
wherein the first fitting portion implemented as a boss, the second fitting portion is implemented as a hole, and the first fitting portion is configured to pass through the second fitting portion, to fix the film on the transport component.

13. The curing device of claim 1, wherein the powder-dispensing component comprises:
a powder-dispensing mechanism configured to dust the hot-melt adhesive powder to the film;
a powder storage mechanism configured to store the hot-melt adhesive powder; and
a powder circulation mechanism, wherein at least part of the powder circulation mechanism is disposed in the powder storage mechanism, the powder circulation mechanism is configured to cyclically move between the powder-dispensing mechanism and the powder storage mechanism, and the powder circulation mechanism is configured to carry part of the hot-melt adhesive powder in the powder storage mechanism, and transport at least some of the part of the hot-melt adhesive powder into the powder-dispensing mechanism.

14. The curing device of claim 13, wherein the powder storage mechanism comprises a powder recovery chamber and a powder storage chamber which are in communication, the powder recovery chamber is closer to the powder-dispensing mechanism than the powder storage chamber, and the powder-dispensing mechanism is disposed above the powder recovery chamber.

15. The curing device of claim 14, wherein the powder storage mechanism comprises a powder storage bin, the powder recovery chamber and the powder storage chamber are defined in the powder storage bin, and the powder storage bin defines a powder recovery port facing upwards; and
wherein the powder storage bin comprises a powder recovery portion and a powder storage portion, the powder recovery portion is disposed above the powder storage portion, the powder recovery portion defines the powder recovery port at an upper end of the powder recovery portion, a chamber width of at least part of the powder recovery portion is gradually decreased from up to down, and a chamber width of at least part of the powder storage portion is gradually decreased from up to down.

16. The curing device of claim 13, wherein the powder circulation mechanism comprises a powder circulation synchronous belt, a transmission structure, and a fourth motor; the transmission structure comprises a driving wheel and a plurality of driven wheels; the driving wheel and the plurality of driven wheels are disposed in a circulation direction of the powder circulation synchronous belt, the driving wheel and the plurality of driven wheels are drivingly connected to the powder circulation synchronous belt, the fourth motor is drivingly connected to the driving wheel, and the fourth motor is configured to drive the driving wheel to rotate to drive the powder circulation synchronous belt to cyclically move along the powder-dispensing mechanism and the powder storage mechanism.

17. The curing device of claim 16, wherein the powder-dispensing mechanism comprises a powder-dispensing bin, a powder-dispensing roller, and a third motor, and the powder-dispensing roller is disposed in the powder-dispensing bin and extends in a length direction of the powder-dispensing bin; and the third motor is configured to drive the powder-dispensing roller to rotate, to make the hot-melt adhesive powder in the powder-dispensing bin dusted downwards onto the film.

18. The curing device of claim 17, wherein the powder circulation mechanism further comprises a powder unloading member disposed above the powder-dispensing bin and at an outer side of the powder circulation synchronous belt, and the powder unloading member is configured to unload hot-melt adhesive powder carried on the powder circulation synchronous belt to allow the hot-melt adhesive powder to fall into the powder-dispensing bin.

19. The curing device of claim 13, wherein the powder-dispensing component further comprises a powder tapping mechanism, the powder tapping mechanism is disposed between the powder-dispensing mechanism and the powder storage mechanism, the powder tapping mechanism is located in a transport path of the film, and the powder tapping mechanism is configured to tap the film dusted with hot-melt adhesive powder to shake off the hot-melt adhesive powder not adhered to the film.

20. The curing device of claim 19, wherein the powder tapping mechanism comprises a fifth motor, a rotating shaft, and at least one tapping member disposed on the rotating shaft, the fifth motor is drivingly connected to the rotating shaft to drive the rotating shaft to rotate, and the tapping member is configured to contact a back of the film to tap the film to shake off the hot-melt adhesive powder on the film.

21. The curing device of claim 1, wherein the curing component comprises:
a box, wherein the box defines an air supply port at an bottom of the box, and the transport component at least surround part of the box;
at least one heating member disposed in the box, wherein the at least one heating member is configured to generate heat; and
an exhaust structure, wherein the exhaust structure is in communication with an interior of the box and is configured to drive air flow in the box.

22. The curing device of claim 21, wherein the curing component further comprises an isolation box, the at least one heating member is disposed in the isolation box, and the isolation box is configured to isolate the at least one heating member from the film.

23. The curing device of claim 21, wherein the exhaust structure comprises an exhaust fan, a first exhaust pipe, and a second exhaust pipe, the exhaust fan is disposed above the box and is in communication with the interior of the box; the first exhaust pipe is in communication with an air outlet of the exhaust fan, and one end of the second exhaust pipe is in communication with the first exhaust pipe, and another end of the second exhaust pipe is configured to be in communication with an external exhaust gas purification device.

24. A printing system, comprising:
a printer configured to print a design on a film; and
a curing device, wherein the curing device comprises a housing, and a powder-dispensing component, a transport component, and a curing component which are disposed within the housing; the housing defines a feeding port and an installation space, the installation space is located outside the housing, the feeding port connects the installation space with an interior of the housing, and the feeding port is configured to allow a film to enter the housing through the feeding port; the powder-dispensing component is disposed between the feeding port and the transport component, and the powder-dispensing component is configured to contain hot-melt adhesive powder and dust the hot-melt adhesive powder to the film; the transport component is configured to transport the film; and the curing component is disposed in a transport path of the film and is configured to cure the film to melt the hot-melt adhesive powder on the film;
wherein the printer is located in the installation space, and the curing device is configured to receive the film printed with the design by the printer and cure the film.
